(19) United States
(12) Patent Application Publication
(10) Pub. No.: US 2014/0274031 A1
(43) Pub. Date: Sep. 18, 2014

(54) SHARING DATA AMONG PROXIMATE MOBILE DEVICES WITH SHORT-RANGE WIRELESS SIGNALS

(71) Applicant: QUALCOMM INCORPORATED, San Diego, CA (US)

(72) Inventor: Jose R. Menendez, Encinitas, CA (US)

(73) Assignee: QUALCOMM Incorporated, San Diego, CA (US)

(21) Appl. No.: 13/801,363

(22) Filed: Mar. 13, 2013

(51) Int. Cl. H04W 52/02; H04W 4/00

(52) U.S. Cl. CPC H04W 52/0209; H04W 4/008
USPC 455/426.1; 455/552.1; 455/41.2

(57) ABSTRACT

Methods, systems and devices for promoting power conservation by sharing data between proximate mobile devices via short-range wireless signals. In an embodiment, a mobile device may determine whether to utilize long-range communications to obtain data, such as music track data. In an embodiment, the mobile device and/or a central server may evaluate load-balancing information, such as the frequency mobile devices within an area obtain data, to determine whether the mobile device should obtain the data. When the mobile device should not obtain data, the mobile device may instead receive data via short-range wireless signals from proximate devices. If the passive data is useful, the mobile device may use the passive data, such as by storing received data in an operating system table. Based on conditions, such as available battery power, the mobile device may also be configured to share obtained or received data by broadcasting short-range wireless signals.

### BACKGROUND

Mobile devices, such as smartphones and tablets with data plans, regularly obtain useful data via long-range communications. In particular, mobile devices may obtain location information for use with maps, navigation, and applications. Applications (or “apps”) running on mobile devices may use location information in similar ways as certain websites utilize zip code information. For example, based on known location information, an application may provide pre-sorted restaurants near the mobile device's location. Mobile devices may obtain location information based on identifying cellular towers over which the mobile devices communicate, but such location information can be imprecise (e.g., ˜800-2000 meters). Mobile devices may also obtain location information based on WiFi information (e.g., the WiFi router location) that may have greater precision, and/or based on global positioning system (“GPS”) data that is very accurate and reliable, especially when mobile devices are outdoors.

However, obtaining location information (or “a location fix”) via GPS communications and/or WiFi requires power-hungry radios within the mobile devices to be activated and utilized, draining significant battery power. When multiple mobile devices are within proximity, battery power may be needlessly expended if many or all of the devices utilize power-hungry components to obtain individual location fixes. On the other hand, short-range wireless transceivers, such as Bluetooth Low Energy (or Bluetooth LE), require relatively small power consumption to broadcast signals capable of being received by other devices within proximity. By utilizing short-range wireless signals, mobile devices may help nearby devices avoid wasteful power consumption and redundant operations by broadcasting location information, ambient music information (e.g., title, artist, lyrics, etc. of a song that can be heard in the vicinity), or other data relevant to an area.

### SUMMARY

The various embodiments provide systems, devices, and methods for promoting power conservation in proximate mobile devices by sharing useful data via short-range wireless signals. Before expending battery power to obtain data, such as location information or information used in applications, a mobile device may be configured to determine whether the mobile device should directly obtain the data at a given time. The mobile device may evaluate load-balancing (or load-sharing) information, such as how often the mobile device utilizes long-range communications to obtain data, as well as other factors to determine whether new data should be obtained via power-hungry communications, such as by receiving satellite signals with a GPS receiver. In an embodiment, a central server may respond to coordination requests and determine when the mobile device should obtain data.

When data should be directly obtained, the mobile device may communicate with and obtain the data from various sources, such as GPS satellites, websites, and remote data servers. However, when data should not be obtained, the mobile device may be configured to receive short-range wireless signals from other devices within proximity. In other words, the burden of obtaining new data may be performed by another device, thereby saving the battery power of the mobile device. If the mobile device receives short-range wireless signals, the mobile device may use any relevant or otherwise useful passive data within the received signals. In an embodiment, passive data received in signals from proximate devices may be useful to the mobile device when the passive data pertains to applications or services supported by the mobile device, the passive data has been recently obtained by the proximate devices (i.e., the passive data is valid or “fresh”), and/or the mobile device does not already have more relevant or recent data.

Additionally, the mobile device may determine whether to broadcast data directly obtained from primary data sources or re-broadcast passive data received from other proximate devices. Based on various conditions, such as available battery life and the number of nearby devices, the mobile device may transmit short-range wireless signals, such as Bluetooth LE, to share data with other devices configured to receive such signals. In an embodiment, the mobile device may be configured to obtain, broadcast, and/or receive GPS fix data, such as GPS coordinates. In another embodiment, the mobile device may be configured to obtain, broadcast, and/or receive music track data, such as song titles, as well as utilize recorded audio data of ambient music to confirm that the received music data pertains to a song still playing near the mobile device.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a communication network that includes a mobile device linked to local wireless communication networks according to an embodiment.

FIG. 2A is a process flow diagram illustrating an embodiment method for a mobile device broadcasting data in response to obtaining or receiving the data from other mobile devices.

FIG. 2B is a process flow diagram illustrating another embodiment method for a mobile device broadcasting data in response to obtaining or receiving the data from other mobile devices.

FIG. 3A is a process flow diagram illustrating an embodiment method for determining whether a mobile device should obtain data from a primary data source.

FIG. 3B is a process flow diagram illustrating an embodiment method for determining whether a mobile device should obtain data based on coordination requests to a central server.

FIG. 3C is a process flow diagram illustrating an embodiment method for a central server to process coordination requests received from a requesting mobile device.

FIG. 3D is a process flow diagram illustrating an embodiment method for a mobile device to determine whether to obtain data based on broadcasts from other devices within a location.

FIG. 4A is a process flow diagram illustrating an embodiment method for a mobile device determining whether passive data received via short-range wireless signals is useful.

FIG. 4B is a process flow diagram illustrating another embodiment method for a mobile device determining whether passive data received via short-range wireless signals is useful.

FIG. 4C is a process flow diagram illustrating an embodiment method for a central server to confirm the validity of short-range wireless signals received by a mobile device.

FIG. 4D is a process flow diagram illustrating another embodiment method for a mobile device determining whether passive data received via short-range wireless signals is useful.

FIG. 5 is a process flow diagram illustrating an embodiment method for a mobile device to determine whether to broadcast data via short-range wireless signals.

FIG. 6 is a process flow diagram illustrating an embodiment method for a mobile device broadcasting GPS fix data in response to obtaining or receiving the GPS fix data.

FIG. 7A is a process flow diagram illustrating an embodiment method for a mobile device broadcasting music track data in response to obtaining or receiving the music track data.

FIG. 7B is a process flow diagram illustrating an embodiment method for a mobile device determining whether music track data received from a short-range wireless signal is useful.

FIG. 8 is a component block diagram of a mobile device suitable for use in an embodiment.

FIG. 9 is a component block diagram of a server device suitable for use in an embodiment.

FIG. 10 is a process flow diagram illustrating an embodiment method for a transmitter device to broadcast relevant data for receipt by proximate mobile devices.

FIG. 11 is a component block diagram of a transmitter device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile device” is used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with a short-range radio (e.g., a Bluetooth® radio, a Peanut® radio, a WiFi radio etc.) and a wide area network connection (e.g., an LTE, 3G or 4G wireless wide area network transceiver or a wired connection to the Internet). In various embodiments, mobile devices may also include a GPS receiver, chip, circuitry, module, or other components for communicating with GPS satellites.

The terms “primary source” and “primary data source” are used herein to refer to any remote server, device, service, or other unit configured to transmit data to a mobile device via long-range communications. Primary data sources may communicate with the mobile device directly, such as via long-range electromagnetic signals, and/or through various devices associated with wide area networks, such as network routers and/or cellular network towers. Primary data sources may also communicate with the mobile device via Internet protocols. Primary data sources may include GPS satellites, data servers, web servers (or websites), and computing devices that may store and deliver data, such as GPS fix data, music track data, weather report data, etc.

For the purposes of this disclosure, data may be obtained directly from primary data sources via long-range communications. The term “passive data” is used herein to refer to data or information the mobile device may receive from proximate devices via short-range wireless signals (e.g., Bluetooth LE messages). For example, passive data may be music track data that the mobile device receives via short-range wireless signals broadcast by a nearby smartphone. Data may be described herein as passive data when not directly obtained from primary data sources via long-range communications. For example, music track passive data may not be received directly from a music data server via Internet protocols, but instead from a proximate tablet device broadcasting that data. Once data is directly obtained from a primary data source by a proximate device, the mobile device may receive that data as passive data within a received short-range wireless signal or message. In other words, data may be passive data whenever received via short-range wireless signals from another mobile device.

The various embodiments provide methods, devices, and systems for obtaining and sharing relevant data with proximate devices via short-range wireless signals. Mobile devices may be configured to receive information via short-range wireless signals from other mobile devices and to obtain the same information from a central source of such information via a long-range communication link. A mobile device may perform an algorithm, such as an operating system thread, software, routine, or application, that informs the mobile device when to expend power to obtain needed data via long-range communications. This determination may be based upon whether the information has been received from other mobile devices, a duration since the information was last obtained, and reliability of information last received by the mobile device. For example, the mobile device may determine that the time since a last GPS fix has exceeded a time threshold and thus the mobile device should obtain a location fix with one or more methods (e.g., WiFi, A-GPS, GPS, etc.). If the mobile device determines that it should obtain the information from the central source, the device may expend the power necessary to establish a long-range communication link with the central source for the information, such as a remote data server, or activate a sensor that can obtain the information, such as a GPS receiver. The mobile device may cache the data it obtains, such as fresh GPS fix data, in operating system tables or in data structures accessing by applications executing on the mobile device. Upon obtaining the information from the central source, the mobile device may begin broadcasting the information via short-range wireless signals.

If the mobile device determines that the information received from other mobile devices is acceptable or preferable to information it already has, the mobile device may utilize the information received via short-range wireless signals received from one or more proximate mobile devices. For example, when suffering from low battery service life, the mobile device may not activate a GPS chip and obtain GPS fix data, but instead may monitor for useful GPS fix data within Bluetooth advertisements broadcast by nearby smartphones. As another example, if the mobile device determines that information received from another mobile device is newer or more reliable than information it has received from another source and stored in memory, such as a more recent GPS fix or a more recent weather or conditions report, the mobile device may use the received data and/or cache the newer or more reliable data in operating system tables or in data structures accessing by applications executing on the mobile device.

Regardless of whether the data is obtained directly from a primary data source (e.g., a remote data server) or received from proximate devices as passive data (e.g., received within Bluetooth LE broadcasts), the mobile device may utilize the received useful data for its normal purposes. For example, fresh GPS fix data received from another near by mobile device may be used as if the fix was obtained by the device's own GPS receiver. As another example, Yelp® data (e.g., a list of top-rated nearby restaurants) received from another mobile device, which may have downloaded the data from a server via a cellular data link, may be stored in memory where it may be accessed by a Yelp® application executing on the mobile device's processor, such as to determine nearby diners. The various embodiments may be used to obtain and cache information for any of a variety of applications that use data that would otherwise require the expenditure of resources (e.g., battery power) to obtain.

In general, the data may be useful to the mobile device (and its user) when it includes information that is relevant, reliable, and otherwise applicable to the mobile device's current location, operating state, or executing applications. For example, useful data may include recent weather information corresponding to the city in which the mobile device is currently located. Conversely, useful data may not include data that is inaccurate or pertaining to a time period and/or location unrelated to the activities of the mobile device. For example, GPS fix data may not be useful to the mobile device when the data was obtained an hour ago when the mobile device was in another location. The data may also be useful when it is associated with software, applications, routines, and/or functions that are performed, supported, and/or executed by the mobile device. For example, useful data may include data formatted for use by a particular application currently executing on the mobile device. However, data that is formatted only for use within an application not installed on the mobile device may not be useful. Also, data that is not useful to a particular mobile device (a first smartphone and/or user) may still be useful to another proximate device (a second smartphone). Thus, an embodiment mobile device may be configured to broadcast data that is not useful to that mobile device, but that may be useful to other proximate devices.

In various embodiments, data obtained directly from primary data sources and/or passive data received within broadcast signals may include GPS fix information (e.g., longitude and latitude GPS coordinates), other location information, music track information (e.g., music track names, play times, artists, etc.), coupons, shopping information (e.g., Black Friday deals), weather reports, local traffic, temperature readings, other types of sensor reading collected by a mobile device and/or data that may be obtained by accessing networks, such as the Internet. A mobile device performing embodiment methods may share any data that it generates or obtains and that may be useful to other devices within proximity of the mobile device. For example, a mobile device may execute a music recognition application (e.g., Shazam®) that utilizes a microphone to record an audio sample of a music track (or song) played in a public place, that it may transmit to a network service, such as Shazam® that returns a name and artist of the music. The obtained audio clip and/or the resulting song match may be shared with nearby mobile devices via short range broadcasts so that all devices within proximity may use their Shazam® application to identify the name of the song and/or play back the clip for confirmation purposes without having to communicate with Shazam®'s network service or minimizing the amount of communication required.

The mobile device may utilize a short-range wireless transceiver (e.g., Bluetooth, Bluetooth LE, Zigbee, Peanut, RF, etc.) to broadcast messages that include data obtained directly from primary data sources or passive data received by the mobile device within short-range wireless signals. Such broadcast messages may also include metadata that indicates timestamp information, related applications, identification information of the mobile device, and other descriptive information associated with the data being broadcast. For example, the metadata may indicate the broadcast message (or broadcast signal) includes music track information and/or weather reports. In an embodiment, the metadata may include information describing its age and/or how many previous recipients have broadcast the data (e.g., the number of “hops”). Additionally, the metadata may include indicators of the error band (or estimated margin of error) of the data being broadcast, as well as other indicators of the certainty of correctness or the applicability range for certain data (e.g., a validity range for GPS coordinates reported within a broadcast signal). In an embodiment, the metadata may include the signal strength for previously received broadcast signals. For example, the metadata may indicate that a first mobile device is re-broadcasting data received from a second mobile device who had re-broadcast the data after receiving it from a third mobile device.

In various embodiments, the mobile device may determine when to obtain data via long-range communications by evaluating various conditions related to the data and the activity of other mobile devices. For example, the mobile device may determine it should obtain data from a remote web server in response to detecting a user input or receiving a command from a central server. The mobile device or a central server may also execute a load-balancing algorithm to determine whether the mobile device should obtain data at a given time. For example, the central server may perform a load-balancing algorithm to determine whether it is the mobile device's “turn” among a community of nearby mobile devices to obtain a GPS fix or to contact a music data server to obtain music track data related to ambient audio played overhead. The purpose of evaluating load-balancing information or performing a load-balancing algorithm is to spread the power costs of obtaining common-use data from primary data sources amongst all mobile devices in an area, therefore avoiding placing an undue burden on any single mobile device's battery. Load-balancing algorithms may be performed to determine which mobile device of a plurality of mobile devices connected to a particular wireless network (e.g., connected to a common cell tower, WiFi access point, etc.) should expend power to obtain data.

In various embodiments, when determining whether to obtain data, the mobile device may evaluate load-balancing factors or conditions, such as the popularity of the area the mobile device is within (e.g., how often mobile devices visit/revisit the location/area), the time since the data was last obtained in the area, how many phones are detected in the immediate vicinity (e.g., how many mobile devices are broadcasting via Bluetooth LE, etc.), how much the phone has been moving around (e.g., accelerometer or gyroscope sensor information indicating movement, etc.), common travel patterns of the mobile device, whether the phone is plugged into a power source (e.g. home, work, airport, car, etc.), the mobile device's remaining battery life, and the GPS signal strength of the mobile device. For example, the central server may determine the mobile device should not obtain GPS fix data based on a high number of nearby smartphones that have adequate available battery power.

In various embodiments, load-balancing algorithms or operations may determine when each of multiple devices should obtain data in order to share the burden of obtaining the information while ensuring reliable information is available. Some redundancies may be required to overcome uncertainties within load-balancing calculations, such as estimated popularity of an area and/or the likelihood that a particular mobile device may be within an area at a certain time. For example, a central server may determine that two different mobile devices within the same area of a mall should obtain music track data from a remote server in order to ensure the music track data may be shared with other mobile devices within the mall in the event that one of the mobile devices loses connectivity during a download of the data, immediately exits the area, etc. However, various load-balancing schemes may utilize a redundancy threshold to prevent too many devices from obtaining data at a given time.

In another embodiment, data or metadata within the broadcast signals may be encrypted, encoded, or otherwise obscured. For example, metadata within a broadcast signal may be encoded so that identification information may not be spoofed to fraudulently broadcast incorrect GPS coordinates. Mobile devices may decode, decrypt, or validate obscured information based on stored tables (e.g., a data table representing all valid mobile devices). Alternatively, mobile devices may request that received signals be validated by a central server. For example, to avoid utilizing inaccurate data broadcast from an unreliable, nefarious source, the mobile device may request the central server to confirm the received broadcast is from a registered user. As another example, registered mobile devices and the central server may each have a cryptographically secure pseudo random number generator algorithm that is used to generate identifiers on a common time scale, so that any given moment, the central server can calculate identifiers transmitted by mobile devices and thus confirm the validity of broadcast signals. In another embodiment, the central server may confirm the validity of passive data within broadcast signals. For example, when devices anonymously broadcast signals with passive data, a validation message may only include the passive data for the central server to determine whether the mobile device can trust the data. In such a case, the central server may independently obtain the data to confirm validity.

In various embodiments, mobile devices may be configured to exchange short-range wireless signals or messages using various wireless technologies, such as LTE-D, peer-to-peer LTE-D, WiFi, Zigbee®, Peanut®, Bluetooth®, Bluetooth LE, RF, WiFi Direct, etc. However, short-range wireless signals are not limited to short-range RF signals, and mobile devices may broadcast other forms of short-range wireless signals, including signals encoded in light, sound, vibration, and heat. For example, mobile devices may emit heat signals, such as infrared light, using infrared light-emitting diodes or other components capable of emitting infrared radiation. Additionally, mobile devices may emit vibration signals using vibration motors and other mechanical components capable of generating controlled vibrations. Mobile devices may also emit light signals from a number of common emitters, such as light emitting diodes, incandescent lights and projectors. Light signals may be received by light sensors (e.g., cameras) on mobile devices, and may include visuals, such as lights, colors, and imagery (e.g., photos, projections, videos, symbols, etc.). Mobile devices may also or alternatively emit audible or inaudible (i.e., infrasonic or ultrasonic) sound signals from a speaker (e.g., a piezoelectric speaker). Sound signals may be received by a microphone of mobile devices, and may include a variety of sounds, such as beeps, voices, noise, clicks, ultrasounds, tones, and musical notes. Emitting sound and/or light in addition to broadcasting RF signals may enable mobile devices, such as smartphones, to recognize when other devices are particularly close (i.e., within audible range or line-of-sight).

FIG. 1 illustrates an embodiment communication network for a mobile device 138 to broadcast short-range wireless signals for receipt by a proximate device 138′. The mobile device 138 may exchange wireless communications with the proximate device 138′ via a short-range wireless data link 12. The wireless communications via short-range wireless data link 12 may be short-range radio transmissions and may utilize radio protocols, such as Bluetooth®, Bluetooth® LE, Zigbee®, Peanut®, etc. In an embodiment, the short-range wireless communications may be light, heat, sound, or any other type of signaling.

The mobile device 138 may also include a long-range radio or wireless transceiver capable of exchanging data with a cellular tower 6 via a long-range data link 10. For example, the mobile device 138 may be equipped with a cellular network modem and an antenna capable of transmitting data transmissions to a 3G, 4G or LTE cellular network. In an embodiment, the long-range (or high-power) data link 10 may require increased power consumption compared to short-range wireless data link 12, and so the mobile device 138 may selectively use the long-range radio to conserve battery power. For example, when receiving broadcasts from the proximate device 138′ via the short-range wireless data link 12, the mobile device 138 may de-activate, turn off, or configure the long-range radio to “sleep” (or be configured to operate in a sleep mode).

In an embodiment, data may be received from the cellular tower 6, such as cell site identification information, general location information, and other data relevant to the cellular network associated with the cellular tower 6. In an embodiment, the mobile device 138 may also include a global positioning system (GPS) chip and receive transmissions from a GPS satellite 50 via a satellite data link 13. For example, the mobile device 138 may receive GPS coordinates (or GPS fix data), along with timestamp information, via the satellite data link 13 when the GPS satellite 50 is in orbit over the mobile device 138. The mobile device 138 may also transmit wireless signals to a wireless router 185 via a wireless data link 188. The wireless router 185 may provide a connection 187 to the Internet 24. The wireless signals via the wireless data link 188 may be WiFi transmissions transmitted by the mobile device 138 via a WiFi transceiver.

In various embodiments, the mobile device 138 may utilize the data links 10, 188 (e.g., long-range radio data link to a cellular network or local area network) to download or otherwise receive data from primary data sources, such as a web server or cloud storage server. For example, an application (or app) executing on the mobile device 138 may initiate a download of data from a remote data server 140 via the long-range data link 10. Primary data sources, such as the remote data server 140, may be third-party devices associated with services that provide useful data, such as weather reports and/or music information, to software executing on the mobile device 138 (e.g., a weather or music recognition app).

The mobile device 138 may establish communications with a data network 4 via a data link 7 from the cellular tower 6. For example, the mobile device 138 may transmit data through the cellular tower 6 to a cellular telephone system. The data network 4 may include switching centers 18 that are coupled in network connections 14 to Internet gateway servers 22 to enable data connections to the Internet 24. The data network 4 may also enable telephone calls to be made to mobile computing devices, such as smartphones, tablet devices, and feature phones. For example, a smartphone mobile device 138 may exchange phone calls and/or SMS text messages with the cellular tower 6 via the long-range data link 10. In an embodiment, the data network 4 may also communicate data, telephone calls, and other information to landline telephones (not shown).

Through the various connections to the Internet 24, the mobile device 138 may transmit communications, such as website data requests, database queries, and download/upload transmissions, to primary data sources (i.e., the remote data server 140) or a central server 120. In an embodiment, the central server 120 may act as a computing device that stores and/or processes data related to load-balancing between the mobile device 138 and the proximate device 138′. In particular, the central server 120 may coordinate when devices 138, 138′ should or should not obtain data from the remote data server 140 and/or other primary data sources (e.g., GPS satellites 50). In various embodiments, the central server 120 may store registration information (e.g., identification information) for the mobile device 138.

In an embodiment, a transmitter device 142 may be configured to exchange messages with proximate mobile devices 138, 138′ via short-range wireless data links 12. The transmitter device 142 may be a device positioned within a place that includes a short-range wireless radio (e.g., Bluetooth transceiver) for broadcasting data that is commonly obtained within or otherwise relevant to the place. The transmitter device 142 may not be configured to obtain data from primary sources via long-range communications (e.g., cellular network, WiFi, etc.), but instead may simply receive data broadcast from other devices 138, 138′ via the wireless data links 12. Further, the transmitter device 142 may be configured to store received data, update stored data with any subsequent, new data received from proximate mobile devices 138, 138′, and broadcast the most recent data via the wireless data link 12. Components and operations of the transmitter device 142 are further described below.

FIG. 2A illustrates an embodiment method 200 for a mobile device broadcasting data in response to obtaining the data from a primary data source or receiving the data from other mobile devices. In determination block 202, the mobile device may determine whether it should obtain data, such as data for use with software or an application (e.g., music track data for a Shazam app) or the mobile device's operating system (e.g., GPS fix data for use in an operating system data table, etc.). As described above, the mobile device may directly obtain data from primary data sources via long-range communications, as opposed to receiving passive data via wireless broadcast signals from other proximate mobile devices. The mobile device may determine whether to obtain data based on evaluating load-balancing information (e.g., frequency of obtaining data), received user inputs, detecting changes in wireless network access points (e.g., the mobile device has moved from one WiFi router/cell tower/cell site to another, etc.), detecting sensor information (or sensor data) that indicates movement (e.g., accelerometer data indicates the mobile device's user is jogging or traveling in a conveyance, etc.), and/or the presence of other proximate mobile devices. Alternative embodiment operations to determine whether the mobile device should obtain data are described below with reference to FIGS. 3A-3B.

If the mobile device should obtain the data (i.e., determination block 202=“Yes”), in block 204 the mobile device may obtain the data via long-range wireless communications, such as transmissions with primary data sources over the Internet. For example, the mobile device may obtain GPS fix data from transmissions received from GPS satellites, or alternatively may obtain application data from a remote data server transmitted over a WiFi network. In block 206, the mobile device may use the obtained data. For example, the mobile device may store obtained GPS coordinate data for use by operating system routines that provide location information to restaurant-finding apps (e.g., Yelp).

If the mobile device should not obtain the data (i.e., determination block 202=“No”), in determination block 208, the mobile device may determine whether a short-range wireless signal is received. Short-range wireless signals may include messages transmitted via protocols such as Bluetooth, Bluetooth Low Energy, Zigbee, Peanut, RF, etc., or alternatively may include light, sound, and/or vibration signals. The mobile device may evaluate a receiving circuit, message queue, or other buffering component that may record or indicate received short-range wireless signals, such as Bluetooth LE broadcast signals. If the mobile device has not received a short-range wireless signal (i.e., determination block 208=“No”), the mobile device may continue to perform the operations in determination block 208. If the mobile device has received a short-range wireless signal (i.e., determination block 208=“Yes”), in determination block 210 the mobile device may determine whether passive data from the received signal is useful. In other words, the mobile device may process the received signal, evaluate any included metadata, and determine whether the signal includes passive data relevant to the mobile device. For example, the mobile device may identify passive data within the received signal that corresponds to a common application currently executing or installed on the mobile device. The mobile device may also determine whether passive data is useful based on whether a margin of error reported within metadata is below a predefined threshold (e.g., is location data precise enough to be used by the mobile device, etc.), a signal strength indicator within the metadata is above a certain strength threshold (e.g., when other devices receive passive data via weak signals, that passive data when re-broadcast may be useless to the mobile device because a weak signal correlates with the source being farther away than when the mobile device is receiving a strong signal), a timestamp indicating passive data that is too old, whether passive data is less current than already stored data within the mobile device, and/or the number of previous recipients of the passive data (i.e., the number of times the passive data has been re-broadcast). Embodiment methods for determining whether passive data is useful are described below with reference to FIGS. 4A, 4B, and 4D.

If the passive data from the received signal is not useful (i.e., determination block 210=“No”), the mobile device may continue with the operations in determination block 214 described below. In other words, when the passive data is not useful to the mobile device, the mobile device may still determine whether to broadcast the passive data so that other proximate devices may determine for themselves whether the passive data is useful. In other words, the mobile device may determine whether to broadcast received passive data independent of the data's usefulness to the mobile device and/or user. In another embodiment, the mobile device may optionally disregard the received signal in optional block 211 and continue with the operations in determination block 202 when the passive data from the received signal is not useful (i.e., determination block 210=“No”).

If the passive data from the received signal is useful (i.e., determination block 210=“Yes”), in block 212 the mobile device may use the received passive data. The operations in block 212 may be similar to the operations in block 206, except that the data used is passive data received from short-range wireless signals as opposed to data obtained directly from a primary data source (e.g., data from a remote server via Internet protocols, GPS satellite, etc.). In determination block 214, the mobile device may determine whether to broadcast the data. In other words, the mobile device may determine whether to broadcast data, such as data obtained directly from primary data sources or passive data received from nearby devices, based on many factors, such as whether the mobile device is outside or inside of a building, the current available service life or power capacity of the mobile device's battery, the number of proximate users (or devices), and/or whether the mobile device is connected to a power source (e.g., the smartphone is plugged into a house power outlet, a car charger, etc.). An embodiment method for determining whether to broadcast the data is described below with reference to FIG. 5.

If the mobile device determines not to broadcast the data (i.e., determination block 214=“No”), the mobile device may continue with the operations in determination block 202. If the mobile device determines to broadcast the data (i.e., determination block 214=“Yes”), in block 216 the mobile device may broadcast the data via short-range wireless signals, such as Bluetooth LE transmissions. In an embodiment, the mobile device may calculate a number of times and/or a period of time to broadcast the data.

FIG. 2B illustrates another embodiment method 250 for a mobile device broadcasting data in response to obtaining the data from a primary data source or receiving the data from other mobile devices. The method 250 is similar to the method 200 described above, except that the method 250 contains additional operations to create metadata describing broadcast signals. In particular, the mobile device may generate metadata indicators that describe data included within short-range wireless broadcast signals transmitted by the mobile device. Similarly, any broadcast signals received by the mobile device may include metadata. For example, when in receipt of a Bluetooth advertisement packet from a proximate device, the mobile device may evaluate metadata within the packet to determine any relevance to software executing on the mobile device's processor.

In determination block 202, the mobile device may determine whether it should obtain data, such as data for use with software or an application (e.g., music track data for a Shazam® app) or the mobile device's operating system (e.g., GPS fix data for use in an operating system data table, etc.). If the mobile device should obtain the data (i.e., determination block 202=“Yes”), in block 204 the mobile device may obtain the data via long-range wireless communications, such as exchanged wireless communications with primary data sources. In block 206, the mobile device may use the obtained data. If the mobile device should not obtain the data (i.e., determination block 202=“No”), in determination block 208, the mobile device may determine whether a short-range wireless signal is received. If the mobile device has not received a short-range wireless signal (i.e., determination block 208=“No”), the mobile device may continue to perform the operations in determination block 208.

If the mobile device has received a short-range wireless signal (i.e., determination block 208=“Yes”), in determination block 210 the mobile device may determine whether passive data from the received signal is useful. If the passive data from the received signal is not useful (i.e., determination block 210=“No”), the mobile device may continue with the operations in determination block 214. In an alternative embodiment, when the passive data is not useful, the mobile device may disregard the received signal in optional block 211 and may continue with the operations in determination block 202. If the passive data from the received signal is useful (i.e., determination block 210=“Yes”), in block 212 the mobile device may use the received passive data. The operations in block 212 may be similar to the operations in block 206, except that the data used is from received short-range wireless signals as opposed to the mobile device obtaining the data directly from a primary data source (e.g., remote server via Internet protocols, GPS satellite, etc.).

In determination block 214, the mobile device may determine whether to broadcast the data. If the mobile device determines not to broadcast the data (i.e., determination block 214=“No”), the mobile device may continue with the operations in determination block 202. If the mobile device determines to broadcast the data (i.e., determination block 214=“Yes”), in block 252 the mobile device may generate metadata based on the data and/or metadata from received signals. For example, the mobile device may generate token, codes, or other indicators that may inform subsequent recipient mobile devices that a broadcast message or signal includes data relevant to a particular application (e.g., a “Yelp” indicator). When the data to be broadcast was previously received from another device (i.e., passive data), the mobile device may generate metadata that indicates the mobile device is re-broadcasting the data.

In various embodiments, the metadata may include indicators describing the number of previous recipient devices that broadcast the data, the use (e.g., relevant applications), timestamp information, location information of the mobile device, the signal strength of signals received by the mobile device when the data is being re-broadcast, and the margin of error associated with the data (e.g., the likelihood the data will be useful to future recipients based on proximity and/or time). In an embodiment, the generated metadata may also include identification information of the mobile device. For example, the mobile device may include metadata indicating the mobile device's MAC address or other unique identifier. Further, the identification information may be encrypted or otherwise encoded. For example, the mobile device may generate metadata that corresponds to the mobile device's identification information that has been encrypted with an encoding algorithm known and used by trusted devices, such as a central server. In an embodiment, metadata may also indicate the periodicity and/or duration the mobile device may broadcast a message. For example, metadata may include the time for a subsequent broadcast from the mobile device or alternatively an indication that the mobile device may no longer broadcast a generated message.

In block 254, the mobile device may generate a message with the data and the generated metadata. For example, the message may include metadata information within header information of a Bluetooth advertisement message that includes GPS fix data as a payload. In optional block 256, the mobile device may activate a short-range wireless transceiver and in block 258 may broadcast the generated message via the short-range wireless transceiver. In optional block 259, the mobile device may deactivate the short-range wireless transceiver. The mobile device may then continue with the operations in determination block 202. In an embodiment, the mobile device may repeat broadcast the generated message numerous times. For example, the mobile device may broadcast the message periodically for a total duration and/or for a total number of times. Such repeat broadcasts may be set by the mobile device based on the data represented in the message. For example, when the message contains data directly obtained from a primary data source by the mobile device, the mobile device may broadcast the message a certain number of times more than when the message contains passive data received via short-range wireless signals from a proximate device. In another embodiment, the mobile device may broadcast the message periodically and/or repeatedly based on the error of margin, the mobile device's remaining battery power, the signal strength of received signals from other devices, and other factors similar to those described above regarding the operations in determination block 210.

FIG. 3A illustrates an embodiment method 300 for determining whether a mobile device should obtain data from a primary data source. As described above, the operations in FIG. 3A may be executed during the operations of determination block 202 with reference to FIGS. 2A-2B. The mobile device may periodically perform the operations in FIG. 3A to detect when new (or refreshed) data used by applications or operating system services needs to be obtained from remote data servers, GPS satellites, or other computing devices reachable via a long-range communication. For example, the mobile device may perform the method 300 to determine whether to transmit a data request to a web server via a cellular network.

In determination block 302, the mobile device may determine whether to obtain data based on load-balancing information. Load-balancing information may include indications of the mobile device's operating conditions or behavior, such as the frequency at which the mobile device obtains data, the last time data was obtained from a primary data source, and previous travel patterns of the mobile device. For example, load-balancing information may include the frequency at which the mobile device obtains GPS fix data from GPS satellites and broadcasts that data via Bluetooth LE. Load-balancing information may also include the number, density, and/or characteristics of other devices within proximity to obtain the data instead of the mobile device. For example, the mobile device may utilize an application that reports estimated positions of all smartphones within proximity that are capable of obtaining and sharing data. As another example, load-balancing information may include information that shows the availability of other devices within the same area based on available battery power and/or supported technologies.

In another embodiment, the mobile device may store load-balancing information for individual data types, applications, and/or services. For example, the mobile device may store load-balancing information that indicates the mobile device should soon obtain GPS fix data but may wait a period before obtaining data for use by a music application. Alternatively, load-balancing information may encompass the mobile device's behavior related to any data that may be obtained and shared. For example, the load-balancing information may indicate that the mobile device may not be required to obtain GPS fix data based on having recently shared data for a music application.

In an embodiment, the mobile device may evaluate a load-balancing variable, algorithm, function, or equation that changes every time the mobile device obtains data from a primary data source or receives passive data from other mobile devices. For example, the mobile device may store and update a system variable that represents the responsibility of the mobile device to obtain data from a remote server. In other words, the mobile device may track its activities over a period and determine when it is the mobile device's turn to expend power obtaining data. Such a load-balancing variable, algorithm, function, or equation may be based on the number of times the mobile device obtains data for sharing with proximate devices, and may change over time to make the mobile device more or less likely to determine it should obtain data. For example, the mobile device may store a counter variable that increases every time cycle that the mobile device does not obtain data or alternatively receives data from another device, and when the counter variable exceeds a predefined threshold value, the mobile device may determine it should obtain data. Alternatively, the mobile device may evaluate load-balancing information that incorporates randomness, such that there is only a random chance the mobile device may determine to obtain data based on load-balancing information. With stored data that represents the historical activities and operating conditions of the mobile device, a fair distribution of work (i.e., battery power expense during data acquisition via long-range communications) may be enabled, thereby preventing the mobile device from indefinitely receiving data from other devices, or alternatively, indefinitely obtaining data for broadcasting to other devices. In another embodiment, the mobile device may perform a load-balancing algorithm that includes operations similar to the operations in blocks 348-360 described below with reference to FIG. 3C.

Return to FIG. 3A, if the mobile device determines that it should obtain data based on load-balancing information (i.e., determination block 302=“Yes”), the mobile device may continue with operations for obtaining data, such as transmitting long-range communications with the operations in block 204 as described above with reference to FIGS. 2A-2B. If the mobile device determines that it should not obtain data based on load-balancing information (i.e., determination block 302=“No”), in determination block 304 the mobile device may determine whether the mobile device has received a user input to obtain data. In other words, the mobile device may detect inputs provided by a user that direct the mobile device to perform operations to obtain data via a long-range communications. For example, the mobile device may detect that the user pressed a rocker button or a soft graphical user interface button corresponding to a command to obtain a GPS fix. In an embodiment, the user input may be represented by sensor data, such as accelerometer data, that corresponds to a command directing the mobile device to obtain data. For example, the mobile device may activate a WiFi transceiver and request data from a remote data server in response to detecting motion data generated by a gyroscope sensor unit. If the mobile device receives user input to obtain data (i.e., determination block 304=“Yes”), the mobile device may continue with operations for obtaining data.

If the mobile device does not receive user input to obtain data (i.e., determination block 304=“No”), in determination block 306, the mobile device may detect a change in wireless network access points, such as the access points the mobile device utilizes to transmit long-range wireless communications. For example, the mobile device may compare the cell tower to which the mobile device is currently connected to stored information representing a previous cell tower. In various embodiments, wireless network access points may include cell towers or sites, WiFi routers, and any other device or networking conduit the mobile device may utilize to exchange transmissions with remote computing devices, servers, or other mobile devices. In an embodiment, the mobile device may detect software events that correspond to changes in connectivity, access points, and/or networks that the mobile device is currently connected. For example, the operating system of the mobile device may receive software events, alerts, or other information that indicates the mobile device has stopped communicating over a particular network in exchange for another network. In another embodiment, the mobile device may determine changes in utilized wireless network access points on a predefined time interval. For example, the mobile device may compare the identity of a current cellular tower to a stored identity of a cellular tower the mobile device was previously communicating over within a few seconds, minutes, or hours. If the mobile device detects a change in wireless network access points (i.e., determination block 306=“Yes”), the mobile device may continue with operations for obtaining data.

If the mobile device does not detect a change in wireless network access points (i.e., determination block 306=“No”), in determination block 308 the mobile device may determine whether a status change is detected based on sensor data. In other words, the mobile device may evaluate sensor data generated by sensors, such as accelerometers, and determine whether updated data should be obtained in response to a change in operating conditions. For example, the mobile device may determine that, based on accelerometer and/or gyroscope sensor data indicating the mobile device has been traveling at a fast velocity (e.g., traveling in a car), the mobile device has moved physical locations and thus requires new GPS coordinates. As another example, in response to not detecting taps, or alternatively detected touch screen inputs, for a certain period, the mobile device may determine the user requires new application data that must be obtained from a data server via Internet protocols. If the mobile device detects a status change based on sensor data (i.e., determination block 308=“Yes”), the mobile device may continue with operations for obtaining data.

If the mobile device does not detect a status change based on sensor data (i.e., determination block 308=“No”), in determination block 310 the mobile device may determine whether stored data is older than an age threshold. For example, the mobile device may require fresh GPS fix data when the latest stored GPS fix data has a timestamp outside of a predefined freshness time period (e.g., an hour, a day, a week, etc.). As another example, a music recognition application may require new music track identification data when the currently stored identification data has a timestamp older than the duration of the last recognized track. If the stored data is older than an age threshold (i.e., determination block 310=“Yes”), the mobile device may continue with operations for obtaining data. If the stored data is not older than an age threshold (i.e., determination block 310=“No”), the mobile device may not obtain data. In other words, the mobile device may not communicate with primary data sources, but instead may wait to receive data from short-range wireless signals broadcast by proximate devices or simply do nothing.

In various embodiments, the mobile device may perform any combination of the operations in determination blocks 302-310 to determine whether data should be obtained. For example, the mobile device may only evaluate load-balancing information to determine whether to communicate with a GPS satellite to obtain GPS fix data.

FIG. 3B illustrates another embodiment method 320 for determining whether a mobile device should obtain data. The method 320 differs from the method 300 in that the mobile device may request a central server to evaluate various conditions (e.g., load-balancing information) to determine whether the mobile device should obtain data. In block 322, the mobile device may transmit a coordination request corresponding to certain data to a central server. In other words, the mobile device may transmit a message that prompts the central server to determine whether the mobile device should obtain data for a particular use, such as for use by a certain application or service employed by the mobile device. For example, the mobile device may transmit a coordination request corresponding to GPS fix data, requesting the central server to respond with an indication of whether the mobile device should obtain a new GPS fix or simply do nothing. The coordination request may be a signal, message, or other communication the mobile device may transmit to the central server via Internet protocols. In various embodiments, the coordination request may include identification information of the mobile device, sensor data (e.g., accelerometer sensor data, most recent GPS fix data, etc.) detected by the mobile device, indicators of utilized applications or services on the mobile device, information describing recent behaviors or events related to the mobile device (e.g., information describing received Bluetooth LE signals within a time period, detected user inputs, etc.), and timestamp information of previously obtained data (e.g., passive data or data obtained directly from a primary data source). For example, the coordination request may contain information describing that the mobile device is requesting the central server to determine whether the mobile device should obtain new data utilized by a particular restaurant-finding application. In an embodiment, the coordination request may include information describing the mobile device's history of sharing data with proximate devices. For example, the coordination request may include statistical information and/or a stored value that indicates how often the mobile device has received passive data as opposed to expended power to obtain data over a period. In another embodiment, coordination requests may include broadcast signals received from proximate devices as well as metadata information that indicates the information within the coordination request and/or included received broadcast signals.

In determination block 326, the mobile device may determine whether a coordination request response is received, such as a response from the central server. The mobile device may evaluate a receiving circuit, message queue, or other buffering component that may record or indicate received messages or wireless signals from the central server. If no coordination request response is received (i.e., determination block 326=“No”), the mobile device may continue to perform the operations in determination block 326.

If a coordination request response is received (i.e., determination block 326=“Yes”), in determination block 328 the mobile device may determine whether the response includes a command to obtain the data. For example, the mobile device may process the received coordination request response message and identify any included commands within the response. The response and operations performed by the central server related to coordination requests are further described below with reference to FIG. 3C. If the response includes a command to obtain the data (i.e., determination block 328=“Yes”), the mobile device may proceed to obtain the data. For example, in response to determining that the response contains a command to obtain the data, the mobile device may perform the operations in block 204 with reference to FIG. 2A. However, if the response does not include a command to obtain the data (i.e., determination block 328=“No”), the mobile device may not obtain the data. For example, the mobile device may enter a wait or sleep cycle for a period or alternatively may evaluate a receiving circuit, queue, or buffer to check for incoming short-range wireless signals from nearby devices.

FIG. 3C illustrates an embodiment method 345 for a central server to process coordination requests received from a requesting mobile device. The operations in method 345 may be performed by the central server in response to coordination request messages or signals transmitted by the requesting mobile device as described above with reference to FIG. 3B. For example, the requesting mobile device may transmit a coordination request that prompts the central server to evaluate load-balancing information and determine whether the requesting mobile device should obtain new GPS fix data.

In general, the method 345 may be utilized by the central server to implement load-balancing algorithms or policies amongst mobile devices and may be performed to identify conditions relevant to power expenditures associated with obtaining data by mobile devices. The central server may be a computing device that has access to and/or stores status information, historical or statistical data, and/or other information related to the requesting mobile device and other similar devices. In other words, the central server may store information for tracking, managing, and/or scheduling certain activities of the requesting mobile device. For example, the central server may be a cloud computing device, data server, or data hub that mobile devices periodically exchange communications with via Internet protocols in order to update account information. In an embodiment, the method 345 may be performed by the central server as an alternative to the requesting mobile device performing the operations of the method 300. For example, the central server may determine when the requesting mobile device may obtain data from primary data sources, such as remote data servers and/or GPS satellites.

In another embodiment, the central server may only perform load-balancing or other coordination operations for mobile devices that are registered with the central server. In other words, the central server may only determine whether a requesting mobile device should obtain data when the requesting mobile device has registered with the central server. In a further embodiment, any load-balancing information the central server may evaluate when determining whether the requesting mobile device should obtain data may include information regarding only other registered devices. For example, the central server may only identify the last time a registered device, not any device, obtained a particular type of data within an area and/or time period.

In determination block 346, the central server may determine whether a coordination request corresponding to certain data is received. For example, the central server may evaluate a receiving queue or buffer to determine whether a message is received from the requesting mobile device. As described above, the coordination request may pertain to a certain type of data, such as GPS fix data, or related application or server, such as a music recognition application. If the central server does not receive a coordination request (i.e., determination block 346=No“), the central server may continue with the operations in determination block 346.

However, if the central server receives a coordination request (i.e., determination block 346=Yes”), in block 348 the central server may identify the current area of the requesting mobile device. In other words, the central server may determine a geographic place in which the mobile device that transmitted the coordination request may be located. The central server may identify the general area based on information within the coordination request, such as included GPS coordinates or metadata indicating the geographical area of the requesting mobile device at the time of transmitting the coordination request. In an embodiment, the central server may identify the current area of the requesting mobile device based on the cell site identification or router identification associated with the coordination request. For example, the central server may identify the cell tower or WiFi router over which the requesting mobile device transmitted the coordination request and may determine the requesting mobile device's general area to be within proximity of the cell tower or WiFi router location.

In an embodiment, the central server may also identify characteristics of the current area, such as the number of cell towers, geographic conditions (e.g., foliage coverage, outside or inside of a building, within a canyon, etc.), and whether the area is urban (e.g., surrounded by tall buildings, in an area with open sky, etc.). For example, based on the identified area, the central server may determine the requesting mobile device is within a hiking area that historically has a small population of mobile users.

Further, the central server may determine the popularity of the identified area, such as how often mobile devices travel within and/or return to the area. The central server may evaluate stored data aggregated by the central server based on previous received coordination requests or other messages from the various mobile devices within the area over a period of time. For example, the central server may calculate a popularity rating for the area around a retail store (e.g., a value that describes the through-put of consumers within the store on an hourly basis). Popularity may also be useful in estimating proximate mobile devices within the area in the future.

In another embodiment, the central server may identify previous common travel patterns of the requesting mobile device to determine the current location of the requesting mobile device. In particular, the central server may detect movement trends based on the time of day, day of the week, month, etc., and may identify the likely current general area or location of the requesting mobile device. Additionally, the central server may perform dead reckoning calculations that utilize previously reported location information of the requesting mobile device over time to estimate the requesting mobile device's current (or future) location. For example, based on previously reported GPS locations of the requesting device over the last hour, the central server may calculate the estimated speed of the requesting mobile device as well as the direction of travel to determine that the requesting mobile device is likely within an area of town covered by a particular cellular tower.

In block 350, the central server may identify the last time the requesting mobile device obtained the data. For example, based on metadata within the coordination request or information stored within the central server, the central server may determine the requesting mobile device has not directly obtained GPS fix data from a GPS satellite in several hours. The central server may compare the elapsed time since the requesting mobile device directly obtained any data to a threshold value. In an embodiment, the central server may also identify the last time the requesting mobile device received useful passive data from another device, such as a mobile device broadcasting GPS coordinates via Bluetooth LE to all devices within proximity.

In block 352, the central server may identify the frequency at which the requesting mobile device obtains the data. In other words, the central server may determine how often the requesting mobile device has received commands or instructions from the central server to expend power to obtain the data. For example, the central server may evaluate the number of times the requesting mobile device is instructed by the central server to obtain GPS fix data over a period of time. Alternatively, the central server may identify how often the requesting device obtained the data based on independent commands (e.g., user input, an internal schedule of the requesting mobile device, etc.). The central server may compare the identified frequency to the frequency other devices in the current area have obtained the data. For example, the requesting mobile device may be commanded by the central server to obtain GPS fix data on average every day, but other devices in the same area may be commanded to request GPS fix data every other day. Alternatively, the central server may identify how often the requesting mobile device obtains the data in response to performing the operations of the method 300. For example, the central server may simply identify how often the requesting mobile device expends power to obtain GPS fix data from GPS satellites over a period of time, regardless of whether the central server transmitted a command or not. In an embodiment, the central server may identify the relative frequency of the requesting mobile device obtaining the data. For example, the central server may determine the requesting device obtains music track data for use by a music application two times as often as any other device within the same area.

In block 354, the central server may identify proximate mobile devices within the identified area. The central server may evaluate stored information that indicates reported locations of other mobile devices and may generate a list of proximate devices. In an embodiment, the coordination request may include metadata indicating devices proximate to the requesting mobile device. For example, the coordination request may indicate the identities of any mobile devices the requesting device has received broadcast signals within a certain time period.

In block 356, the central server may identify the last time any mobile device obtained the data. The operations in block 356 may be important in determining whether any up-to-date data is potentially available in the general area. In particular, the central server may evaluate stored information to determine how recently any device, including the requesting mobile device and any identified proximate mobile devices, in the identified general area obtained the data from a primary data source. For example, the central server may evaluate a database storing information related to previous coordination requests from various devices and determine the most recent time any device obtained the data while within the identified area or current location of the requesting mobile device. Alternatively, the central server may evaluate previous response transmissions from the central server to various devices to determine the last time the central server commanded a device to obtain the data.

In block 358, the central server may identify the availability of mobile devices within the identified area to obtain and broadcast the data. The central server may evaluate characteristics and/or operating states of the requesting mobile device and the identified proximate mobile devices to determine whether any may obtain the data via long-range communications. For example, the central server may evaluate stored data and/or information within the coordination request to determine whether any mobile devices within the identified area have activated long-range transceivers, such as WiFi radios. As another example, availability may be based on mobile devices within the identified area having cellular network data plans, signal strength exceeding a predefined threshold, and installed applications, software, or services related to the data that are capable of being executed by the mobile devices. In other words, the central server may identify whether mobile devices are configured to obtain the data. In an embodiment, the central server may further identify availability based on whether mobile devices are configured to broadcast signals via a short-range wireless transmitter, such as a Bluetooth radio. In an embodiment, the central server may also identify availability based on the reported activities of the mobile devices identified to be within the area. For example, a mobile device that is currently conducting a computation-intensive operation, such as a software routine that utilizes substantial processor resources, may not be identified as available.

In block 360, the central server may identify available power of mobile devices in the identified area, such as the requesting mobile device and any other mobile devices identified as within the area. For example, the central server may evaluate metadata within the coordination request that indicates the requesting mobile device's available battery capacity.

In determination block 362, the central server may determine whether the requesting mobile device should obtain the data. In general, the central server may determine the requesting mobile device should obtain the data based on any or all of the identification operations in blocks 348-360. For example, the central server may determine the requesting mobile device should obtain the data when the requesting mobile device has not obtained the data recently, when the requesting device has not obtained the data as often as other nearby devices, when no other devices are within proximity, and/or when other proximate devices in the same general location are not available (e.g., proximate devices have battery power lower than the requesting device's battery power, etc.). The central server may utilize an equation, function, or other decision-marking module to utilize the identified information in the operations in blocks 348-360. In various embodiments, when performing the operations in determination block 362 to determine whether the requesting mobile device should obtain the data, the central server may perform any combination of the identifications or evaluations in blocks 348-360. For example, the central server may determine the requesting mobile device should obtain GPS fix data based exclusively on the identified availability of other proximate mobile devices. In another embodiment, the central server may utilize any or all of the identifications in blocks 350-360 with varying weights or importance. For example, the central server may determine the requesting mobile device should obtain the data when many other devices are within proximity but none of these proximate devices have a high level of battery power available. In an alternative embodiment, the central server may utilize a randomness variable, function, or other decision-making mechanism to determine whether the requesting mobile device should obtain the data. For example, the central server may utilize a random-number generator in addition to the identification operations to determine whether the requesting mobile device should obtain GPS fix data in the identified area.

If the central server determines the requesting mobile device should obtain the data (i.e., determination block 362=“Yes”), in block 364 the central server may transmit a response (or coordination response message) that includes a command for the requesting mobile device to obtain the data. In other words, the central server may direct the requesting mobile device to expend battery power to obtain the data via long-range communications. The command may be a bit, a code, software instructions, a flag, an indicator, or any other information that the requesting mobile device may process to cause the performance of operations to obtain the data. For example, the command may be a code (e.g., “GET”) known by the requesting mobile device as an instruction to begin receiving communications from a GPS satellite in order to obtain GPS coordinates. In optional block 365, the central server may also transmit a message indicating that the requesting mobile device should broadcast the obtained data, such as the data obtained from a primary data source. In other words, the central server may transmit messages that both instruct the mobile device to obtain the data and to broadcast that data once obtained so that proximate devices may also benefit. In an embodiment, the central server may indicate that the requesting mobile device should broadcast any obtained data within the response transmitted with the operations in the block 364. For example, the response may include a bit or other code that indicates any subsequent data obtained in response to the requesting mobile device receiving the response should be broadcast by the requesting mobile device.

If the central server determines the requesting mobile device should not obtain the data (i.e., determination block 362=“No”), in block 366 the central server may transmit a response that includes a command for the requesting mobile device to wait for data from another mobile device. Similar to as described above with reference to the operations in block 364, the response may include a command or other instructions that the requesting mobile device may associate with operations. In an embodiment, the command may cause the requesting mobile device to enter a sleep mode. In another embodiment, the command may instruct the requesting mobile device to wait, sleep, or otherwise not request the data for a predefined period. For example, the response may include a command that indicates the requesting mobile device may transmit another request to the central server in another second, minute, or hour.

In block 368, the central server may store information corresponding to the received coordination request and the transmitted response. For example, the central server may record in a data table any commands transmitted to the requesting device, such as commands to obtain the data, as well as the time of transmission of such commands and the characteristics of the data, such as related applications or services. The central server may then continue with the operations in determination block 346. In an embodiment, the central server may update load-balancing variables or other conditions related to the requesting mobile device based on the transmitted response. In particular, the central server may modify stored variables that indicate when the requesting mobile device may be commanded to obtain the data in the future based on the transmitted response and included command. For example, when the response includes a command for the requesting mobile device to wait or otherwise not obtain the data, the central server may adjust a variable to increase the likelihood that the central server may determine the requesting device should obtain the data in response to subsequent coordination requests.

In an embodiment, the operations in blocks 348-360 of the method 345 may be performed by the requesting mobile device separately. For example, the requesting mobile device may store or otherwise acquire information used in the identification operations in blocks 348-360 to determine whether to obtain the data.

FIG. 3D illustrates an embodiment method 375 for a mobile device to determine whether to obtain data based on broadcasts from other devices within a location. Instead of utilizing a central server (e.g., a cloud server) to coordinate load-balancing (or load-balancing) between various devices within a location, the devices may be configured to self-organize. In particular, a plurality of mobile devices within a particular place or location, such as a mall, may communicate to form a mesh network and exchange information indicating the conditions under which the devices may volunteer to obtain data from primary sources. For example, the mobile devices belonging to mall workers may exchange times during the work day when each may volunteer to obtain weather reports from a remote weather server via a cellular network. In an embodiment, devices may utilize a common WiFi connection, such as Social WiFi. With this self-organizing technique, mobile devices having a historical association with the place and thus more likely to benefit from the data may assume a heavier burden for obtaining data relevant to the place than devices irregularly or inconsistently moving through the place. For illustration purposes, within a mall, consumers walking through the mall may not be burdened to obtain data, only the mobile devices of employees of the mall may “volunteer” to obtain data.

In block 376, the mobile device may identify an availability to obtain data based on locally stored data. In other words, the mobile device may evaluate data representing previous behaviors (e.g., locations, available power, workloads, etc.) to detect times and conditions when the mobile device may be able to obtain data relevant to its current location from primary sources. The mobile device may analyze historical information describing the frequency and duration that the mobile device has been located near its current location. For example, the mobile device may evaluate stored data that represents travel routes, GPS coordinates, and/or access points that the mobile device communicated over for a certain period of time to determine a period of time when the mobile device may be available to obtain data relevant to the current location. In an embodiment, the mobile device may utilize Gimbal® technology to analyze historical location information associated with the mobile device. For example, the mobile device may employ Gimbal® software operations to identify known travel patterns of the mobile device (e.g., areas where the user of the mobile device periodically visits). In an embodiment, the mobile device may also evaluate previous connectivity, such as cellular network coverage, associated with the location to determine how available the mobile device may be to obtain data. For the purpose of illustration, the mobile device may be used by a store worker who goes to work in a mall every weekday from 9:00 AM to 5:00 PM. The mobile device may determine an availability to obtain data relevant to the mall location as anytime during such a work schedule based on stored data indicating consistent GPS coordinates, available battery service life, and connectivity for the mobile device. In an embodiment, the locally stored data may include availability information previously received from proximate devices, and the mobile device may identify its availability as times and/or conditions not coinciding with the availability information previously received from these other devices. For example, having stored data received from a device used by another mall worker that indicates a first work shift of the other mall worker, the mobile device may identify its availability to obtain weather data relevant to the mall's zip code as including a second work shift that is not coincident to the first work shift.

In block 378, the mobile device may broadcast a message indicating the availability to proximate devices. For example, the mobile device may utilize a Bluetooth LE radio to broadcast a signal that indicates the times during the day the mobile device may volunteer to obtain data from a remote server. Alternatively, the mobile device may broadcast its availability via a local area network, such as a WiFi network. In an embodiment, the message may include metadata, header information, tokens, bits, or other information that indicates the broadcast is related to load-balancing for a particular place or location, and may also include a range of times and conditions that the mobile device has volunteered as acceptable conditions for the mobile device to carry a burden of obtain data.

In block 380, the mobile device may receive response messages from proximate devices that include scheduling information. In particular, in response messages may include availability information of the proximate devices, conditions and/or time throughout a period claimed by proximate devices (e.g., a smartphone in a mall has indicated it will always obtain updated restaurant review information at a certain time of day each day), and/or confirmations of the availability information transmitted with the operations in block 378. For example, the response messages may include indications that proximate devices have coinciding availabilities to obtain data, unique circumstances related to their ability to obtain data (e.g., data plan limitations, lists of applications installed on the various devices, permissions that enable/disallow obtaining certain data, etc.). In an embodiment, the response messages may include an indicator, flag, or other information that indicates the mobile device may or may not be required to obtain data while within proximity of the proximate devices. For example, a response message may indicate that based on the mobile device's broadcast availability information, a proximate device may always obtain data instead of the mobile device.

In block 382, the mobile device may establish conditions to obtain data for the current location based on identified availability and received response messages. In other words, the mobile device may compare the availability identified with the operations in block 376 with the scheduling information received from proximate devices to determine the times and conditions when the mobile device may obtain data. Conditions may include a time of day and a day of the week during which the mobile device volunteers to obtain data from a primary data source. For example, the mobile device in a mall may establish a time every hour (e.g., every two minutes) during a certain day (e.g., Wednesday) when the mobile device may use a cellular network connection to obtain music track data related to audio sensor data corresponding to whatever music is playing over the loudspeakers of a mall at that time. The conditions may also include thresholds for battery service life, the number of times the mobile device has obtained data within a period (e.g., a week, month, year, etc.).

In determination block 384, the mobile device may determine whether the established conditions are met, such as by evaluating the conditions with current sensor data, time, calendar information, available battery power, and other factors. If the established conditions are met (i.e., determination block 384=“Yes”), the mobile device may determine that it should obtain the data. For example, when the mobile device determines that the current time on an internal clock matches the established time for the mobile device to obtain weather data for a zip code, the mobile device may engage its cellular modem to communicate with a remote weather data server.

However, if the established conditions are not met (i.e., determination block 384=“No”), the mobile device may determine that it should not obtain the data. For example, if the current time of day has been claimed by a proximate device, the mobile device may not actively obtain weather data but instead may listen for broadcast signals from the proximate device.

FIGS. 4A-4D illustrate various methods for determining whether passive data is useful to a mobile device. For example, the method 400 may be performed to determine whether received passive data can be used by an app installed on the mobile device. However, it is important to note that regardless of whether passive data is determined by the mobile device to be useful, the mobile device may still perform operations to determine whether to rebroadcast the passive data for use by nearby devices. For example, even when received music track data is determined to not be useful to the mobile device, using the operations described above with reference to determination block 214 or the operations described below with reference to FIG. 5, that mobile device may still determine whether to rebroadcast the music track data for receipt and use by nearby smartphones.

FIG. 4A illustrates an embodiment method 400 for a mobile device determining whether passive data received via short-range wireless signals is useful. Mobile devices within proximity may share obtained data via short-range wireless signals, such as Bluetooth LE signals. However, based on various considerations, such as the time of obtaining the data and/or the location in which the data was obtained, data within such signals may not benefit a recipient mobile device. For example, a recipient mobile device may receive a Bluetooth LE signal that includes passive data of GPS coordinates that do not accurately represent the actual location of the recipient mobile device due to the coordinates having too large of a margin of error. As another example, passive data within a received signal may correspond to an application or software package that the recipient mobile device does not support (e.g., the application is not installed). Accordingly, a mobile device receiving broadcast signals from other devices within proximity may perform the operations of the method 400 to evaluate data and/or metadata within received signals and determine whether the passive data is relevant or otherwise useful to the mobile device.

The operations of the method 400 may be performed by the mobile device in place of or during the operations of determination block 210 described above with reference to FIGS. 2A-2B. In other words, the mobile device may perform the operations of the method 400 in response to determining a short-range wireless signal, such as a Bluetooth LE message, has been received by the mobile device.

In block 402, the mobile device may evaluate metadata and passive data within the received signal. In particular, the mobile device may process the received signal to identify, categorize, and otherwise interpret metadata and passive data within the signal. For example, the mobile device may parse the received signal to identify metadata and associated passive data corresponding to GPS fix data. In determination block 404, the mobile device may determine whether the received signal includes passive data relevant to an application or service on the mobile device. For example, the mobile device may compare identification tags associated with passive data included in the received signal to accessible, installed, or otherwise known software, apps, routines, or services utilized by the mobile device. If the received signal does not include passive data that is relevant to an application or service on the mobile device (i.e., determination block 404=“No”), the mobile device may determine the passive data within the received signal is not useful. For example, the mobile device may disregard the received signal.

However, if the received signal includes passive data that is relevant to an application or service on the mobile device (i.e., determination block 404=“Yes”), in determination block 406 the mobile device may determine whether a margin of error exceeds an error threshold. In other words, the mobile device may determine whether metadata within the received signal indicates a margin of error that is larger than a predefined threshold value corresponding to errors for the passive data. As data is broadcast and rebroadcast, each broadcasting mobile device may calculate a margin of error or other metric of the accuracy of the data within the signals being broadcast. For example, when re-broadcasting GPS fix data that was received from another device, the mobile device may append metadata that indicates how reliable or accurate the GPS fix data is to the mobile device. In an embodiment, as successive mobile devices receive passive data, the margin of error may increase. For example, over time, as GPS fix data is shared numerous times between mobile devices, the margin of error of the GPS fix data may increase each with each broadcast until the margin of error indicates the passive data (i.e., GPS fix data) is too broad to be useful. If the margin of error exceeds the error threshold (i.e., determination block 406=“Yes”), the mobile device may determine the passive data is not useful and may disregard the received signal.

If the margin of error does not exceed the error threshold (i.e., determination block 406=“No”), in determination block 408 the mobile device may determine whether the signal strength of the received signal is less than a strength threshold. In other words, the mobile device may determine whether the received signal was transmitted by a device that was too far from the mobile device. The signal strength may be important to discount data within the received signal as the signal strength may indicate the proximity of the mobile device to the transmitting device. For example, if the signal strength is below the strength threshold, the received signal may include GPS fix passive data that is not close enough to the mobile device's current position to be accurate with regards to the mobile device. In an embodiment, the mobile device may also evaluate metadata within the received signal that indicates the signal strength of any re-broadcast data. For example, if the received signal includes music track data that was previously broadcast, the received signal may include metadata that describes the signal strength of the previous broadcast of the music track data. If the signal strength of the received signal is less than the strength threshold (i.e., determination block 408=“Yes”), the mobile device may determine the passive data is not useful and may disregard the received signal.

If the signal strength of the received signal is not less than the strength threshold (i.e., determination block 408=“No”), in determination block 410 the mobile device may determine whether the received signal timestamp is greater than an age threshold. In other words, the mobile device may determine whether the passive data within the received signal is too old to be useful to the mobile device. In particular, devices may broadcast a message or signal multiple times without updating or otherwise changing the data included in the message. For example, a device may receive GPS fix data that is broadcast periodically for a few seconds, a minute, or an hour. So, the mobile device may check the timestamp associated with passive data of the received signal to ensure “freshness” of the passive data. In an embodiment, timestamp metadata may describe the time the data was obtained from a primary data source (e.g., a GPS satellite) and/or the time of each rebroadcast. If the signal timestamp is greater than the age threshold (i.e., determination block 410=“Yes”), the mobile device may determine the passive data is not useful and may disregard the received signal.

If the signal timestamp is not greater than the age threshold (i.e., determination block 410=“No”), in determination block 412 the mobile device may determine whether the passive data is older than stored data. In particular, the mobile device may compare timestamp information or metadata associated with passive data within the received signal to timestamp information associated with similar data stored by the mobile device. For example, although the timestamp of GPS fix data within the received signal may not exceed the mobile device's age threshold value (e.g., GPS fix data may be too old if not obtained within the previous minute, etc.), the mobile device may have obtained and stored GPS fix data more recently than the GPS fix data in the received signal was obtained. As another example, the mobile device may have previously received a short-range wireless signal including more recently obtained application data than the passive data included in the current received signal. In other words, passive data that was obtained by another device prior to stored data within the mobile device may not be useful. If the passive data is older than the stored data (i.e., determination block 412=“Yes”), the mobile device may determine the passive data is not useful and may disregard the received signal.

If the passive data is not older than the stored data (i.e., determination block 412=“No”), in determination block 414 the mobile device may determine whether the number of previous recipients exceeds a “hop” threshold. In other words, the mobile device may evaluate metadata that indicates the number of devices that have broadcast the passive data (i.e., the number of hops) to determine whether the passive data is still relevant. For example, the mobile device may determine that once a certain number of other devices have received and rebroadcast GPS fix data, the GPS fix passive data may no longer be relevant or accurate to the mobile device's current location. If the number of previous recipients exceeds the hop threshold (i.e., determination block 414=“Yes”), the mobile device may determine the passive data is not useful and may disregard the received signal. However, if the number of previous recipients does not exceed the hop threshold (i.e., determination block 414=“No”), the mobile device may determine the passive data is useful and may perform operations to utilize the passive data with the operations in block 212 described above with reference to FIGS. 2A-2B.

In various embodiments, the various thresholds (e.g., signal strength threshold, hop threshold, age threshold, etc.) may be different for different types of passive data included in received signals. For example, the signal strength threshold may be higher for GPS fix data than for shopping data (e.g., Black Friday deals/coupons). In other embodiments, the mobile device may perform a combination of the determinations in determination blocks 404-414. In particular, the determinations the mobile device performs may be dependent upon the type of passive data within the received signal. For example, when the passive data within the received signal is Black Friday shopping data, the mobile device may not determine the number of previous recipients, as such shopping information may be useful regardless of how many shoppers have received the information. In a further embodiment, the mobile device may utilize weighting algorithms or policies that emphasize the importance of particular determinations regarding the usefulness of passive data. For example, the mobile device may determine passive data is useful when metadata indicates a low margin of error but a high number of previous recipients.

FIG. 4B illustrates another embodiment method 450 for a mobile device determining whether passive data received via short-range wireless signals is useful. The method 450 is similar to the method 400 described above, except that the mobile device may validate received signals by verifying the identity of the broadcasting device. Certain data may be crucial to the health and activities of the user of the mobile device. For example, GPS fix data may be used by the mobile device to inform navigation applications that guide the user during travel. However, if nefarious persons broadcast false, spoofed, or incorrect data, the user of the mobile device may be lead into danger or encounter other difficulties. To protect against spoofed data, the mobile device may transmit messages to a central server that is configured to validate that received signals were broadcast by registered or otherwise valid devices. As described above, in an embodiment, the central server may store and manage a registry of all users and/or devices that are registered, trusted, or otherwise verified as legitimate.

In block 402, the mobile device may evaluate metadata and passive data within the received signal. In determination block 404, the mobile device may determine whether the received signal includes passive data relevant to an application or service on the mobile device. If the received signal does not include passive data that is relevant to an application or service on the mobile device (i.e., determination block 404=“No”), the mobile device may determine the passive data within the received signal is not useful. However, if the received signal includes passive data that is relevant to an application or service on the mobile device (i.e., determination block 404=“Yes”), in block 452 the mobile device may transmit a validation message based on the received signal to a central server. In an embodiment, the validation message may include the identification of the device that broadcast the received signal. For example, the validation message may include a code that indicates the mobile device requires confirmation regarding a particular MAC address, Bluetooth MAC address, user identifier, or other identifying information the mobile device may detect within the received signal. Such identifying information may be encrypted, encoded, or otherwise obscured so that the mobile device may not identify the transmitting device of the received passive data. In an alternative embodiment, the validation message may instead include the received passive data such that the central server may verify the validity of the data. For example, the validation message may include information indicating the best nearby restaurants (i.e., data from a Google search result) with metadata indicating verification of the information is requested by the mobile device. Transmitting a validation message that includes received passive data may be important when proximate devices broadcast passive data anonymously. For example, when there is no transmitting device identity within a received broadcast signal, the mobile device may need to verify the correctness of received passive data in lieu of trusting the passive data based simply on it being received from a known device.

In determination block 454, the mobile device may determine whether a confirmation message is received from the central server. For example, the mobile device may receive a message from the central server indicating that the identification of the device that broadcast the received signal is or is not registered to broadcast such signals. In an alternative embodiment, the confirmation message may simply include a token, bit, metadata, or other information that verifies, confirms, or otherwise accepts the passive data as legitimate for the mobile device. If no confirmation message is received (i.e., determination block 454=“No”), the mobile device may determine the passive data within the received signal is not useful. However, if a confirmation message is received (i.e., determination block 454=“Yes”), the passive data may be considered from a valid device. In determination block 406 the mobile device may determine whether a margin of error exceeds an error threshold. If the margin of error exceeds the error threshold (i.e., determination block 406=“Yes”), the mobile device may determine the passive data is not useful and may disregard the received signal. If the margin of error does not exceed the error threshold (i.e., determination block 406=“No”), in determination block 408 the mobile device may determine whether the signal strength of the received signal is less than a strength threshold.

If the signal strength of the received signal is less than the strength threshold (i.e., determination block 408=“Yes”), the mobile device may determine the passive data is not useful and may disregard the received signal. If the signal strength of the received signal is not less than the strength threshold (i.e., determination block 408=“No”), in determination block 410 the mobile device may determine whether the received signal timestamp is greater than an age threshold. If the signal timestamp is greater than the age threshold (i.e., determination block 410=“Yes”), the mobile device may determine the passive data is not useful and may disregard the received signal. If the signal timestamp is not greater than the age threshold (i.e., determination block 410=“No”), in determination block 412 the mobile device may determine whether the passive data is older than stored data. If the passive data is older than the stored data (i.e., determination block 412=“Yes”), the mobile device may determine the passive data is not useful and may disregard the received signal. If the passive data is not older than the stored data (i.e., determination block 412=“No”), in determination block 414 the mobile device may determine whether the number of previous recipients exceeds a “hop” threshold. If the number of previous recipients exceeds the hop threshold (i.e., determination block 414=“Yes”), the mobile device may determine the passive data is not useful and may disregard the received signal. However, if the number of previous recipients does not exceed the hop threshold (i.e., determination block 414=“No”), the mobile device may determine the passive data is useful and may perform operations to utilize the passive data with the operations in block 212 described above with reference to FIGS. 2A-2B.

FIG. 4C illustrates an embodiment method 475 for a central server to confirm the validity of short-range wireless signals received by a mobile device. The method 475 may be performed by the central server in response to the mobile device performing the operations in block 452 described above with reference to FIG. 4B. For example, the central server may perform the method 475 concurrently with the mobile device performing the method 450.

In block 476, the central server may store identification information for mobile devices at registration. For example, prior to broadcasting short-range wireless signals for receipt by proximate mobile devices, a mobile device may be required to be registered with the central server to ensure only trusted or verified devices provide data. In determination block 478, the central server may determine whether a validation message is received, such as a validation message transmitted by the mobile device. For example, the central server may monitor a receiving circuit, buffer, or queue that is associated with validation messages transmitted by mobile devices. If a validation message is not received (i.e., determination block 478=“No”), the central server may continue to perform the operations in determination block 478. If a validation message is received (i.e., determination block 478=“Yes”), in determination block 480 the central server may determine whether identification information is included for verification. The central server may detect identification information related to a broadcast signal within the validation message. For example, the central server may parse and evaluate metadata and/or header information of the received validation message to identify included identifiers related to a broadcast signal received by the mobile device. If identification information is included (i.e., determination block 480=“Yes”), in determination block 482, the central server may determine whether identification information is known to the central server. In other words, if any identification information related to a received signal is transmitted by the mobile device in the received validation message, the central server may determine whether that identification information corresponds to a registered device and/or user. The central server may compare any detected identification information from the validation message to the identification information stored during the registration of various devices and/or parties, and when the central server matches detected identification information to the stored identification information, the associated data received by the mobile device may be considered trusted data. In various embodiments, the central server may decrypt, decode, or otherwise process the identification information in order to determine an identity that may be compared to stored lists (or databases) of known parties. For example, the central server may use a decryption cipher known to registered devices to determine whether the identification information is known.

If no identification information is included for verification (i.e., determination block 480=“No”), or if the identification information is not known (i.e., determination block 482=“No”), in determination block 484 the central server may determine whether passive data is included for verification. As described above, a mobile device may transmit a validation message including passive data when the passive data has been received from anonymous proximate devices that do not identify themselves within broadcast messages. So, the validation messages may be sent to the central server in order to verify correctness of the passive data that cannot otherwise by trusted.

If passive data, such as weather report information or music track data, is included in the validation message (i.e., determination block 484=“Yes”), in determination block 486 the central server may determine whether the included passive data is valid. The central server may perform various operations to determine the validity of the passive data. For example, the central server may analyze the passive data to determine whether the data conforms to known or standard formatting indicative of valid data. In an embodiment, the central server may transmit messages to remote servers to independently obtain information for comparison with the passive data. For example, the central server may request weather data for the area corresponding to the mobile device that transmitted the validation message in order to determine whether the passive data indicates the correct weather information. The central server may validate passive data using metadata within the validation message that indicates the supposed primary source of the passive data. For example, the central server may request information from a website indicated within the validation message to confirm the passive data. In an optional embodiment, if the central server cannot determine whether the passive data is valid or not, such as when there is insufficient data within the validation message to confirm to deny the correctness of the passive data or when primary sources are unavailable to provide corroborating information (e.g., a web server is temporarily inaccessible).

If the passive data is not included in the validation message (i.e., determination block 484=“No”) or if the passive data is not valid (i.e., determination block 486=“No”), in optional block 488 the central server may transmit a rejection message to the mobile device that transmitted the received validation message and then may continue with the operations in determination block 478. For example, the rejection message may include software instructions that the mobile device may execute to disregard a received broadcast signal from the device having the unknown identity. In other words, if a validation message is received that cannot be confirmed due to lack of information or correct data, the central server may not transmit a confirmation message. In an embodiment, such a rejection message may also include instructions for the mobile device to not rebroadcast un-verified or untrustworthy data.

If the identification information is known (i.e., determination block 482=“Yes”), or the included passive data is valid (i.e., determination block 486=“Yes”), in block 490 the central server may transmit a confirmation message to the mobile device that transmitted the validation message. The confirmation message may include a code, software instructions, or commands the mobile device may utilize to continue processing the received broadcast message and the included passive data. For example, the confirmation message may indicate that the identification information corresponds to a known, trusted device (e.g., the smartphone of a user registered with the central server) and so the mobile device that transmitted the validation message may trust the passive data as accurate. In block 492, the central server may store data from the validation message. For example, the central server may record the time of receipt of the validation message in relation to the identification information confirmed, as well as any other information included in the validation message (e.g., GPS fix data, the identity of the mobile device transmitting the validation message, etc.). The central server may then continue performing the operations in determination block 478.

FIG. 4D illustrates another embodiment method 495 for a mobile device determining whether passive data received via short-range wireless signals is useful. The method 495 is similar to the method 450 described above, except that the mobile device may validate received signals by verifying the identity of the broadcasting device based on a locally stored list of trusted identities.

In block 402, the mobile device may evaluate metadata and passive data within the received signal. In determination block 404, the mobile device may determine whether the received signal includes passive data relevant to an application or service on the mobile device. If the received signal does not include passive data that is relevant to an application or service on the mobile device (i.e., determination block 404=“No”), the mobile device may determine the passive data within the received signal is not useful. However, if the received signal includes passive data that is relevant to an application or service on the mobile device (i.e., determination block 404=“Yes”), in determination block 496 the mobile device may determine whether the received signal contains identification information known to the mobile device. The mobile device may detect identifiers, such as identification codes, within the received signal and compare these identifiers to stored lists of trusted device identities. The stored list may be generated by the mobile device based on received user input, such as a contacts list, or based on information downloaded from a remote source, such as a central server that maintains lists of all trusted or registered users and/or devices.

If the received signal does not contain identification information known to the mobile device (i.e., determination block 496=“No”), the mobile device may determine the passive data within the received signal is not useful as it was broadcast by an unknown device. However, if the received signal contains identification information known to the mobile device (i.e., determination block 496=“Yes”), the passive data may be considered received from a valid device. In determination block 406 the mobile device may determine whether a margin of error exceeds an error threshold. If the margin of error exceeds the error threshold (i.e., determination block 406=“Yes”), the mobile device may determine the passive data is not useful and may disregard the received signal. If the margin of error does not exceed the error threshold (i.e., determination block 406=“No”), in determination block 408 the mobile device may determine whether the signal strength of the received signal is less than a strength threshold.

If the signal strength of the received signal is less than the strength threshold (i.e., determination block 408=“Yes”), the mobile device may determine the passive data is not useful and may disregard the received signal. If the signal strength of the received signal is not less than the strength threshold (i.e., determination block 408=“No”), in determination block 410 the mobile device may determine whether the received signal timestamp is greater than an age threshold. If the signal timestamp is greater than the age threshold (i.e., determination block 410=“Yes”), the mobile device may determine the passive data is not useful and may disregard the received signal. If the signal timestamp is not greater than the age threshold (i.e., determination block 410=“No”), in determination block 412 the mobile device may determine whether the passive data is older than stored data. If the passive data is older than the stored data (i.e., determination block 412=“Yes”), the mobile device may determine the passive data is not useful and may disregard the received signal. If the passive data is not older than the stored data (i.e., determination block 412=“No”), in determination block 414 the mobile device may determine whether the number of previous recipients exceeds a “hop” threshold. If the number of previous recipients exceeds the hop threshold (i.e., determination block 414=“Yes”), the mobile device may determine the passive data is not useful and may disregard the received signal. However, if the number of previous recipients does not exceed the hop threshold (i.e., determination block 414=“No”), the mobile device may determine the passive data is useful and may perform operations to utilize the passive data with the operations in block 212 described above with reference to FIGS. 2A-2B.

FIG. 5 illustrates an embodiment method 500 for a mobile device to determine whether to broadcast data via short-range wireless signals. In general, the mobile device may be configured to share any data that may be used in services, applications, routines, and/or other software common to similar mobile devices. In particular, when data is directly obtained from primary data sources via long-range communications or received from short-range broadcast signals (i.e., “passive” data), the mobile device may in turn broadcast the obtained or received data to benefit other nearby devices that may utilize that data. The mobile device may regularly broadcast such data to relieve other proximate devices from expending battery power to obtain the same or similar data. However, although certain short-range wireless technologies, such as Bluetooth LE, are power efficient, the mobile device may evaluate various conditions to determine whether to broadcast data. For example, the mobile device may evaluate current available power and nearby devices to determine whether sharing the data is warranted or otherwise worth the expense to the mobile device. In various embodiments, the mobile device may perform the method 500 to determine whether to rebroadcast received passive data, regardless of whether the passive data is useful to that particular mobile device and/or user. For example, the mobile device may determine whether to rebroadcast received music track data even when the mobile device itself is not configured with a music app that can utilize the music track data.

In another embodiment, the mobile device may perform various operations of determination blocks 406-414 as part of the method 500. In other words, the mobile device may evaluate any combination of information related to data (e.g., margin of error, timestamp, signal strength, number of previous recipients, etc.) when determining whether to rebroadcast the data via short-range wireless transmissions. For example, the mobile device may be configured to determine that music track data should be rebroadcast to proximate devices because the data's timestamp is very recent.

In various embodiments, the method 500 may be performed by the mobile device during the operations in determination block 214 described above with reference to FIGS. 2A-2B. For example, the mobile device may perform the method 500 once data obtained via long-range wireless communications or received from proximate devices via short-range wireless signals is used with the operations in block 206 or block 212 with reference to FIG. 2A.

In optional determination block 501, the mobile device may determine whether a message has been received indicating data should be broadcast. For example, as described above with reference to FIG. 3C, a central server may transmit a message to the mobile device in combination with (or within) a response message that indicates that the mobile device should obtain the data from a primary data source and broadcast received data to nearby mobile devices. In an embodiment, such a received message may instruct the mobile device to set a system variable, bit, or other indicator that indicates the mobile device should broadcast the obtained data. If a message indicating the mobile device should broadcast data has been received (i.e., optional determination block 501=“Yes”), the mobile device may continue with the operations in optional block 510 and may broadcast the data. If a message indicating the mobile device should broadcast data has not been received (i.e., optional determination block 501=“No”), in determination block 502, the mobile device may determine whether the mobile device is outside. Broadcasting while outdoors may be correlated with the broadcast signal traveling farther than indoors. Therefore, whether the mobile device is outside may be an important factor in determining whether to broadcast data. In an embodiment, the mobile device may compare current GPS coordinates to known geofence information, such as stored schematics and/or perimeter coordinates, to determine whether the mobile device is within a building. Alternatively, the mobile device may determine whether outside or inside a building based on connectivity information. For example, the mobile device may determine it is within a building based on communications with a WiFi router within a building. As another example, the mobile device may determine it is outside of a known building based on weak or low signal strength of recently received signals from other devices. Similar to determining whether the mobile device is outside, in another embodiment, the mobile device may be configured to determine whether the mobile device is indoors or otherwise inside a structure, such as a building, garage, parking deck, subterranean installation, etc., and to rebroadcast GPS data over Bluetooth LE signals when it is indoors. This may be important as GPS signals do not penetrate well structures and soil, so such rebroadcasting may be a technique for extending the effective range of GPS signals. If the mobile device is not determined to be outside (i.e., determination block 502=“No”), the mobile device may not broadcast data.

If the mobile device is determined to be outside (i.e., determination block 502=“Yes”), in determination block 503 the mobile device may determine whether it is in a desolate area, such as a rural farmland, a forest, or a desert. When the mobile device is within a desolate area, the chances of other mobile devices being within proximity and thus able to receive a broadcast may be slight. For example, few other smartphones may be within proximity of each other in the middle of a dessert. The mobile device may compare GPS coordinates or other available location data to population maps and/or other stored information indicating the general demographics, population, or characteristics of the area in which the mobile device is currently located. For example, the mobile device may determine it is within a desolate area by determining the current GPS coordinates of the mobile device coincide with a national park or wildlife preserve. If the mobile device is within a desolate area (i.e., determination block 503=“Yes”), the mobile device may not broadcast data.

If the mobile device is not within a desolate area (i.e., determination block 503=“No”), in determination block 504 the mobile device may determine whether its battery capacity exceeds a battery threshold value. For example, the mobile device may identify whether the battery has enough remaining service life to broadcast Bluetooth signals for a period time and still provide power for operating other functions for a predefined duration. As another example, the mobile device may be configured to not broadcast data once the available battery power is less than a certain percentage value. If the battery capacity does not exceed the battery threshold (i.e., determination block 504=“No”), the mobile device may not broadcast the data. However, if the battery capacity does exceed the battery threshold (i.e., determination block 504=“Yes”), in determination block 506 the mobile device may determine whether a number of proximate devices exceeds a users threshold. In other words, the mobile device may determine whether a certain number of proximate devices (or local users) exist. In an embodiment, the mobile device may download or otherwise receive information indicating the number and estimated location of nearby devices that may be configured to share data with and receive data from the mobile device. For example, the mobile device may execute an application that tracks all devices that are coordinated by a central server associated with sharing data, such as GPS fix data. If the number of proximate devices does not exceed the users threshold (i.e., determination block=“No”), the mobile device may not broadcast the data.

If the number of proximate devices exceeds the users threshold (i.e., determination block=“Yes”), in determination block 508, the mobile device may determine whether it is connected to a power source, such as a wall outlet or a power jack in a car. When connected to such a power source, the mobile device may have access to an indefinite amount of power and thus may easily expend power to broadcast data. If the mobile device is not connected to a power source (i.e., determination block=“No”), the mobile device may not broadcast the data. However, if the mobile device is connected to a power source (i.e., determination block=“Yes”), in determination block 509 the mobile device may determine whether an error band exceeds an error threshold. For example, if the error band, or a margin of error value, of GPS fix data received from a proximate device is too high, meaning that the GPS fix data may represent too large of an area to be useful to any subsequent devices, the mobile device may not broadcast. If the error band exceeds the error threshold (i.e., determination block 509=“Yes”), the mobile device may not broadcast the data.

If the error band does not exceed the error threshold (i.e., determination block 509=“No”), in optional block 510 the mobile device may calculate a period of time to broadcast the data. The period may be a time when the mobile device continually or periodically broadcasts the data. The mobile device may calculate a longer or shorter period of time to broadcast the data, and in an embodiment such a calculation may be based on the information associated with the operations in determination blocks 502-508, such as whether a certain number of local users are nearby. For example, if many local users are nearby, the calculated period of time may be long to ensure many users have an opportunity to receive the data. As another example, if the battery capacity is only slightly above the battery threshold, the mobile device may calculate a shorter period of time to broadcast the data. In an embodiment, the mobile device may calculate a number of cycles to broadcast the data as well as period of time to sleep or pause in between broadcasts.

In another embodiment, the mobile device may perform any combination or order of the operations in the method 500. Additionally, the mobile device may be configured to determine whether to broadcast based on an overall function, equation, or routine that incorporates the determinations or evaluations in the operations in determination blocks 502-508. For example, the mobile device may determine to broadcast data when connected to a power source, regardless of whether the mobile device is in a desolate area. In an embodiment, the mobile device may determine to broadcast data when within a desolate area (e.g., a forest) but also within proximity of several other mobile devices. For example, the mobile device may be carried by a hiker on a remote nature trail with several other hikers carrying smartphones, and so broadcasting the data may be useful. As an illustration, a trail master leading a troop of hikers may broadcast downloaded data that identifies the type of bird associated with an audio clip of a bird call recorded by the trail master's smartphone.

FIG. 6 illustrates an embodiment method 600 for a mobile device broadcasting GPS fix data. The method 600 is similar to the method 250 described above, except that the method 600 contains additional operations that may be directly relevant to obtaining, receiving, and/or utilizing GPS fix data. In particular, the mobile device may configure software modules, components, and/or connected hardware associated with GPS fix data to be active and expend power to obtain new GPS fix data.

In determination block 602, the mobile device may determine whether it should obtain new GPS fix data. In an embodiment, an operating system table (referred to in FIG. 6 as “OS table”) may be accessed and used by various operating system threads, routines, and services that may provide data to various software or applications executing on the mobile device. For example, operating system threads may deliver GPS fix data to a maps app, a proximity shopping app, and/or a nearby restaurant application (e.g., Yelp) executing on the mobile device. The mobile device may determine new GPS fix data is required based on the timestamp of currently stored GPS fix data within the operating system table. For example, the mobile device may receive an operating system event that indicates the GPS fix data is out-of-date once the currently stored GPS fix data is older than a threshold age value (e.g., an hour, a day, etc.). In various embodiments, the mobile device may perform the operations described above with reference to FIGS. 3A-3B when determining whether to obtain new GPS fix data.

If the mobile device should obtain the data (i.e., determination block 202=“Yes”), in block 604 the mobile device may activate a GPS receiver. For example, the mobile device may energize a GPS chip, antenna, and/or circuitry to obtain the data via long-range wireless communications, such as through electromagnetic transmissions from GPS satellites in orbit above the mobile device. In general, the GPS receiver and associated circuitry may be activated or energized and inversely deactivated or de-energized in order to conserve mobile device battery power. The mobile device may activate the GPS receiver with the operations in block 604 and determine GPS fix data periodically and only as needed to optimize battery service life. In an embodiment, the mobile device may activate any components, circuitry, or modules within the mobile device needed to assist in obtaining GPS fix data, such as long-range transceivers utilized in A-GPS communications.

In block 605, the mobile device may receive transmissions from GPS satellites. In particular, the mobile device may receive electromagnetic transmissions from multiple GPS satellites in orbit above the mobile device. In an embodiment, the mobile device may further receive GPS-related information from other remote devices, such as A-GPS servers that may communicate information to assist in obtaining GPS fixes. In block 606, the mobile device may obtain GPS fix data. Based on the received transmissions from the GPS satellites, the mobile device may calculate location information, such as longitude and latitude coordinates. The mobile device may additionally calculate a timestamp value corresponding to the obtained GPS fix data, which may coincide with timestamp information received within satellite transmissions. In block 608, the mobile device may deactivate the GPS receiver. For example, the mobile device may de-energize circuitry, modules, antennas, or other components required to receive GPS satellite transmissions and calculate GPS coordinates. In block 610, the mobile device may store the obtained GPS fix data in the operating system table. For example, the mobile device may overwrite previously stored longitude and latitude values in the operating system table. In an embodiment, the mobile device may store the obtained GPS fix data in a memory or cache location corresponding to current location information and may maintain previous GPS fix data as historical location information. For example, previous GPS fix data may be stored and utilized to determine movement trends of the mobile device.

If the mobile device should not obtain new GPS fix data (i.e., determination block 602=“No”), in determination block 208, the mobile device may determine whether a short-range wireless signal is received. If the mobile device has not received a short-range wireless signal (i.e., determination block 208=“No”), the mobile device may continue to perform the operations in determination block 208. If the mobile device has received a short-range wireless signal (i.e., determination block 208=“Yes”), in determination block 612 the mobile device may determine whether GPS fix passive data from the received signal is useful. For example, the mobile device may compare timestamp information associated with the GPS fix passive data to timestamp information associated with GPS fix data already stored in the operating system table to determine whether the GPS fix passive data is more recent. In various embodiments, the mobile device may perform the operations described above with reference to FIGS. 4A, 4B, and 4D to determine whether GPS fix passive data from the received signal is useful.

If the GPS fix passive data from the received signal is not useful (i.e., determination block 612=“No”), the mobile device may continue with the operations in determination block 214 to determine whether to rebroadcast the data as described above. In another embodiment, the mobile device may optionally continue with the operations in optional block 211 (i.e., the mobile device may disregard the received signal and continue with the operations in determination block 602). However, if the GPS fix passive data from the received signal is useful (i.e., determination block 612=“Yes”), in block 614 the mobile device may store the received GPS fix passive data in the operating system table. The operations in block 614 may be similar to the operations in block 610, except that the GPS fix passive data used is passive data from received short-range wireless signals as opposed to data the mobile device obtained directly from the primary data source of GPS satellites. In block 615, the mobile device may provide the stored GPS fix data to an application (or app) executing on the mobile device. In other words, the stored GPS fix data, whether obtained directly or received as passive data from a short-range wireless signal, may be utilized on demand by applications, operating system threads, and/or other routines executing on the mobile device. For example, an app, such as Yelp, may request the stored GPS fix data be provided by an operating system thread or routine so that the application may find nearby restaurants to display.

In determination block 214, the mobile device may determine whether to broadcast the data, such as the GPS fix data obtained via the GPS receiver or GPS fix passive data received via a short-range wireless signal from a proximate device. If the mobile device determines not to broadcast the data (i.e., determination block 214=“No”), the mobile device may continue with the operations in determination block 602. If the mobile device determines to broadcast the data (i.e., determination block 214=“Yes”), in block 252′ the mobile device may generate metadata, including error band information, based on the data and/or metadata from received signals. The mobile device may generate token, codes, or other indicators that may inform recipient mobile devices of circumstances or conditions related to the GPS fix data, in particular the level of accuracy or relevance (i.e., error band information). For example, the mobile device may generate metadata that indicates included GPS fix data may have a deviation of several feet, yards, or meters in any direction. The error band information may include a range indication that describes the geographic area, distance, or radius that is encompassed by the GPS fix data reported in the message being broadcast by the mobile device. For example, the error band metadata may indicate that included GPS fix data may correspond to any place existing within a few feet, several yards, a city block, or a county.

In an embodiment, the mobile device may generate error band metadata based on previously received error band information from received broadcast signals from proximate devices. For example, the mobile device may append additional error (i.e., increase the range of the error band) to error band information (or metadata) within a received broadcast signal. The amount of modification of error band information may be dependent upon the number of previous recipients of the associated GPS fix data, the signal strength of the received signal, and/or sensor data. For example, the mobile device may increase the error band information dramatically when sensor data indicates the mobile device is traveling within a car. In another embodiment, the mobile device may determine not to broadcast a message that includes the GPS fix data when the generated metadata corresponds to an error band that exceeds a particular threshold. For example, the mobile device may self-govern the broadcasting of GPS fix data that has too large of an error band (e.g., the error band indicates that the GPS fix data may be accurate within a very large geographic area, such as a city, etc.).

In block 254, the mobile device may generate a message with the data and the generated metadata. In optional block 256, the mobile device may activate a short-range wireless transceiver and in block 258 may broadcast the generated message via the short-range wireless transceiver and may continue with the operations in determination block 602.

FIG. 7A illustrates an embodiment method 700 for a mobile device broadcasting music track data. The method 700 is similar to the method 250 described above, except that the method 700 contains additional operations that may be directly relevant to obtaining, receiving, and/or utilizing music track data. In general, the mobile device may execute applications (or apps) that perform operations to recognize or otherwise identify music. For example, the mobile device may execute an app, such as Shazam, that utilizes recorded music data to identify a corresponding song or “music track.” For illustration purposes, when a user of the mobile device desires to know the music track title related to ambient music playing over a loudspeaker, the user may prompt the mobile device executing a music recognition application to communicate with a remote server and obtain music track data that includes the music track title. As many people near the user may also desire to know the music track title, as well as other information about the ambient music, the mobile device may broadcast the obtained music track data via Bluetooth LE signals.

In determination block 702, the mobile device may determine whether it should obtain new music track data. In various embodiments, the mobile device may perform the operations described above with reference to FIGS. 3A-3B when determining whether to obtain new music track data. For example, the mobile device may obtain new music track data in response to detecting user input, such as a soft keyboard button press corresponding to a command to identify music currently playing overhead. If the mobile device should obtain new music track data (i.e., determination block 702=“Yes”), in block 704 the mobile device may record audio data via a microphone. For example, the mobile device may employ a microphone coupled to the mobile device's processor to receive ambient sounds to be stored as audio data (e.g., a way sound file, an mp3 sound file, etc.). In block 705, the mobile device may activate a long-range transceiver, such as a WiFi radio. The mobile device may activate, energize, or otherwise make wake any module, circuitry, software, or other component related to the long-range transceiver and necessary to transmit messages via the long-range transceiver. For example, the mobile device may initialize a communication module utilized by the operating system for transmitting wireless signals over a cellular network. In block 706, the mobile device may transmit a request message based on the recorded audio data to a music server. The request message may include formatting information (e.g., codes, bits, tokens, metadata, etc.) that the music server may utilize to perform evaluation procedures to identify the corresponding music track. Further, the request message may also include metadata, header information, codes, or other indicators that describes the audio data (or characteristics of the audio data), the time of recording the audio data, the identity of software utilized by the mobile device (e.g., the software used with the microphone to record the audio data, an application executing on the mobile device related to music track data, etc.), and the identity of the mobile device. In an embodiment, the request message may contain the audio data or samples of the audio data.

In block 707, the mobile device may receive a response from the music server. For example, the mobile device may receive a data packet formatted for use by a music identification application executing on the mobile device. In block 708, the mobile device may obtain music track data from the received response. In particular, the mobile device may parse or otherwise access any data within the received response, such as music track titles, track durations, artist names, publishing years, genre categories, and other related information to the audio data. In block 709, the mobile device may deactivate the long-range transceiver. In an embodiment, the mobile device may configure the long-range transceiver and associated circuitry to operate in a sleep mode that consumes diminished battery power. In block 710, the mobile device may use the obtained music track data with a music app, such as a music identification application (e.g., Shazam®). The music track data may be stored and used by the music application to display music track information, such as the artist's name, render associated images (e.g., pictures of the artist, album, record label, etc.), and provide directions for downloading or purchasing related products. For example, the music track data may be used by the music application to suggest associated artists and/or online sellers (e.g., Amazon, EMusic, etc.) of related music.

If the mobile device should not obtain new music track data (i.e., determination block 702=“No”), in determination block 208, the mobile device may determine whether a short-range wireless signal is received. If the mobile device has not received a short-range wireless signal (i.e., determination block 208=“No”), the mobile device may continue to perform the operations in determination block 208. However, if the mobile device has received a short-range wireless signal (i.e., determination block 208=“Yes”), in determination block 712 the mobile device may determine whether the music track passive data from the received signal is useful. To determine whether the music track passive data is useful, the mobile device may perform the operations described below with reference to FIG. 7B. Alternatively, the mobile device may perform operations as described above with reference to FIGS. 4A, 4B, and 4D.

If the music track passive data from the received signal is not useful (i.e., determination block 712=“No”), the mobile device may continue with the operations in determination block 214. In another embodiment, the mobile device may optionally continue with the operations in optional block 211 (i.e., the mobile device may disregard the received signal and continue with the operations in determination block 702). However, if the music track passive data from the received signal is useful (i.e., determination block 712=“Yes”), in block 714 the mobile device may use the music track passive data with the music app. The operations in block 714 may be similar to those described above with reference to block 710, except the music track passive data may be passive data from the received signal as opposed to data directly obtained via response messages from the remote music server. In an embodiment, the mobile device may store the music track passive data, only to be used when the corresponding music application is engaged by the mobile device's user. For example, the music application may be executing as a background routine on the mobile device when the music track passive data is received and stored.

In determination block 214, the mobile device may determine whether to broadcast data, such as music track data obtained from the music server or received via short-range wireless signals (i.e., music track passive data). If the mobile device determines not to broadcast the data (i.e., determination block 214=“No”), the mobile device may continue with the operations in determination block 202. If the mobile device determines to broadcast the data (i.e., determination block 214=“Yes”), in block 252 the mobile device may generate metadata based on the data and/or metadata from received signals. In block 254, the mobile device may generate a message with the data and the generated metadata. In optional block 256, the mobile device may activate a short-range wireless transceiver and in block 258 may broadcast the generated message via the short-range wireless transceiver and may continue with the operations in determination block 702.

FIG. 7B illustrates an embodiment method 750 for a mobile device determining whether music track passive data received from a short-range wireless signal is useful. The method 750 may be similar to the methods 400, 450, or 490 described above with reference to FIGS. 4A, 4B, and 4D, except the method 750 may include operations to enable the mobile device to verify music track data received from a proximate device. For example, when received short-range wireless signals including passive data do not meet certain criteria, such as having a timestamp occurring within a certain period, the mobile device may not immediately disregard the signals. Instead, the mobile device may use audio data within the received short-range wireless signals to assist in confirming the accuracy of the passive music track data. For example, the mobile device may identify a music track by comparing audio recorded by a microphone to a known music track identified in a received short-range wireless signal instead of comparing the audio to an entire catalogue of music tracks.

In block 402, the mobile device may evaluate metadata and passive data within the received signal. In determination block 752, the mobile device may determine whether the received signal includes passive data relevant to a music application, such as a music identification application or service executing on the mobile device. For example, the mobile device may determine whether the received signal includes metadata indicating a music track identity (i.e., the name of the track) or other data used by the Shazam® app. If the received signal does not include passive data relevant to a music application or service on the mobile device (i.e., determination block 752=“No”), the mobile device may determine the passive data within the received signal is not useful. For example, the mobile device may disregard the received signal.

However, if the received signal includes passive data that is relevant to a music application on the mobile device (i.e., determination block 752=“Yes”), the received signal may include music track passive data. In determination block 754, the mobile device may determine whether the difference between a timestamp and current time exceeds the known length of a music track. In other words, based on the music track passive data, the mobile device may calculate the difference between timestamp information within the received signal (e.g., metadata indicating when the music track data was obtained by a proximate device) and the time the mobile device received the signal, and compare the difference to the length of the music track indicated by the music track passive data (e.g., metadata indicating the music track duration). So, when the short-range wireless signal was received after the corresponding music track or song was no longer playing, the mobile device may determine the passive data is not useful. For illustration, the received signal may include metadata indicating the music track has a duration (or play time) of one minute and a timestamp indicating the time the music track data was obtained from a music server. But, as the mobile device may have received the received signal over one minute after the time indicated by the timestamp, the music track passive data may no longer be useful as the music track has likely finished playing. This determination may be valuable in dismissing music track passive data when proximate devices may broadcast obtained music track data longer than is necessary or relevant.

If the difference between the timestamp and current time exceeds the known length of the music track (i.e., determination block 754=“Yes”), the mobile device may determine the passive data is not useful. If the difference between the timestamp and current time does not exceed the known length of the music track (i.e., determination block 754=“No”), in determination block 756 the mobile device may determine whether the number of previous recipients is less than a first hop threshold value. The first hop threshold may represent a predefined number of devices that may receive and re-broadcast the music track passive data via wireless signals before the music track data may be considered not useful. In other words, the more previous recipient devices, the greater the likelihood that the mobile device may receive the music track passive data in an area that is not proximate to the ambient music corresponding to the music track passive data. For example, music track passive data corresponding to a song playing at a backyard barbeque may not be relevant to the mobile device as several devices have re-broadcast the music track passive data away from the barbeque. In an embodiment, the first hop threshold may be set based on the signal strength of the received signal, user configuration inputs, and/or conditions, such as the characteristics of the area the mobile device is located in (e.g., outside, inside, in a restaurant/bar, etc.) and the number and/or estimated position of proximate devices. If the number of previous recipients is less than a first hop threshold value (i.e., determination block 756=“Yes”), the mobile device may determine the music track passive data is useful.

If the number of previous recipients is not less than a first hop threshold value (i.e., determination block 756=“No”), the mobile device may perform further operations to determine whether the music track passive data is useful. In particular, the mobile device may use the music track passive data to minimize the effort required to obtain useful music track primary data. In determination block 758, the mobile device may determine whether the number of previous recipients exceeds a second hop threshold. The second hop threshold may be a predefined number. If the number of previous recipients does not exceed the second hop threshold (i.e., determination block 758=“No”), in block 760 the mobile device may record a short sample of audio data via microphone. In other words, the audio sample may have a short duration. For example, the mobile device may record a second of ambient sound accessible to the mobile device. If the number of previous recipients exceeds the second hop threshold (i.e., determination block 758=“Yes”), in block 762 the mobile device may record a long sample of audio data via microphone. In other words, the audio sample may have a long duration. For example, the mobile device may record several seconds of ambient sounds. The operations in blocks 760 and 762 may be similar to the operations in block 704 described above with reference to FIG. 7A, except the various audio data may be of predefined sizes such that the operations in block 760 produce a smaller sample of audio data than the audio data recorded with the operations in block 762.

In block 706′, similar to as described above with reference to block 706, the mobile device may transmit a request message to a music server based on the recorded audio data and the music track passive data. In particular, the request message may include the audio data recorded with the operations in either block 760 or block 762 along with instructions for the music server to confirm (or deny) the recorded audio data corresponds to the music track passive data. In determination block 764, the mobile device may determine whether a confirmation is received from the music server. In other words, the mobile device may receive a confirmation that the recorded audio data corresponds to the music track passive data. If the mobile device receives a confirmation (i.e., determination block 764=“Yes”), the music track passive data may be useful. If the mobile device does not receive a confirmation (i.e., determination block 764=“Yes”), the music track passive data may not be useful. For example, in response to the music server comparing the short or long audio data recorded by the mobile device to the music track passive data and determining no match, the mobile device may receive a rejection message from the music server. In an embodiment, if the mobile device does not receive a confirmation from the music server, the mobile device may obtain music track data by performing the operations in blocks 704-710 described above with reference to FIG. 7A. In another embodiment, instead of the operations in block 706′ and determination block 764, the mobile device may perform confirmation procedures based on recorded audio data. For example, the mobile device may evaluate recorded audio data and the music track passive data to determine whether the audio data and music track passive data match both relate to the same song.

FIG. 8 is a system block diagram of a smartphone-type mobile device 138 suitable for use with various embodiments. The mobile device 138 may include a processor 801 coupled to internal memory 802, a display 803, and to a speaker 854. Additionally, the mobile device 138 may include an antenna 804 for sending and receiving electromagnetic radiation that may be connected to a wireless data link and/or long-range wireless signal transceiver 805, such as a cellular network or WiFi radio, coupled to the processor 801 and capable of communicating over a wide area wireless communication network. Mobile devices may include a separate short-range radio transceiver 824 capable of communicating or pairing with other mobile devices. Mobile devices 138 typically may also include menu selection buttons or rocker switches 808 for receiving user inputs. Additionally, the mobile device 138 may include an accelerometer 810, a gyroscope 811, and a GPS receiver chip 814 coupled to the processor 801. In an embodiment, the mobile device 138 may also include a microphone 812 and a camera 813 coupled to the processor 801.

The various embodiments may be implemented on any of a variety of commercially available server devices, such as the server 120 illustrated in FIG. 9. Such a server 120 typically includes a processor 901 coupled to volatile memory 902 and a large capacity nonvolatile memory, such as a disk drive 903. The server 120 may also include a floppy disc drive, compact disc (CD) or DVD disc drive 906 coupled to the processor 901. The server 120 may also include network access ports 904 coupled to the processor 901 for establishing data connections with a network 905, such as a local area network coupled to other broadcast system computers and servers.

The processors 801 and 901 may be any programmable microprocessor, microcomputer or multiple processor chip or chips that can be configured by software instructions (applications) to perform a variety of functions, including the functions of the various embodiments described below. In some mobile receiver devices, multiple processors may be provided, such as one processor dedicated to wireless communication functions and one processor dedicated to running other applications. Typically, software applications may be stored in the internal memory 802, 902, and 903 before they are accessed and loaded into the processors 801 and 901. The processors 801 and 901 may include internal memory sufficient to store the application software instructions.

FIG. 10 illustrates an embodiment method 1000 for a transmitter device to broadcast relevant data for receipt by proximate mobile devices. As described above, the transmitter device may be a device that is in a fixed position within a heavily trafficked place, such as a mall, an airport, or an amusement park. Instead of performing operations to obtain data from primary sources, the transmitter device may only be configured to receive passive data and broadcast that data when useful. In particular, the transmitter device may broadcast data that is relevant to the place in which it is positioned, such as data frequently obtained by devices within proximity (e.g., data relevant to frequently asked questions or frequently executed Internet searches within proximity of the place). For example, the transmitter device may be installed or otherwise positioned within a mall and may broadcast various data relevant to the mall, such as data indicating the best rated restaurants within the mall.

In determination block 208, the transmitter device may determine whether a short-range wireless signal is received, such as Bluetooth LE broadcast messages from proximate mobile devices that have obtained data via Internet searches. If a signal is received (i.e., determination block 208=“Yes”), in determination block 210, the transmitter device may determine whether passive data from the received signal is useful. To make this determination, the transmitter device may perform the operations described above with reference to FIGS. 4A-4D. In particular, the transmitter device may evaluate the received passive data to data stored within the transmitter device to determine whether the received data is newer. Additionally, the transmitter device may analyze the received data to determine whether the data pertains to the place in which the transmitter device is positioned. For example, the transmitter device may detect that the received passive data indicates restaurant ratings for establishments near the transmitter device. As another example, the transmitter device may detect that the passive data indicates search results for the nearest bathroom in the place, the best club to visit within the city, or common tourist destinations near the place. In other words, the transmitter device may determine received passive data is useful when the data is newer than similar data stored within the transmitter device or when the data is relevant to attractions within proximity of the transmitter device.

If the received passive data is useful (i.e., determination block 210=Yes“), in block 1006 the transmitter device may update stored data with the received data. For example, the transmitter device may overwrite currently stored data with the received data when the received data includes newer information (e.g., a more recent timestamp). When the transmitter device has not previously stored data similar to the received data, updating the stored data may include updating a database within the transmitter device to represent the new, received data. For example, if the transmitter device has not previously stored information related to nearby merchants, the transmitter device may append the received data related to merchants to a stored data table.

If the received passive data is not useful (i.e., determination block 210=No”), or if a signal is not received (i.e., determination block 208=“No”), in determination block 1008 the transmitter device may determine whether it has any stored data to broadcast. For example, the transmitter device may evaluate a database to detect whether any fresh, relevant, or otherwise useful data has been stored in response to received broadcast signals from proximate mobile devices. If there is no stored data to broadcast (i.e., determination block 1008=“No”), the transmitter device may continue with the operations in determination block 208. However, if there is stored data to broadcast (i.e., determination block 1008=“Yes”), in block 216 the transmitter device may broadcast the data via short-range wireless signals. For example, the transmitter device may broadcast messages via Bluetooth LE that indicate the name of the song and artist of the song playing on the loudspeakers in the mall in which the transmitter device is positioned. In optional block 1012, the transmitter device may wait a period, such as a predefined number of milliseconds, seconds, or minutes, and then may continue with the operations in determination block 208.

For the purpose of illustration, a transmitter device may be positioned outside of a movie theater. A display associated with the movie theater may include a quick response code (i.e., a QR code). A first user carrying a first mobile device may use the first mobile device to scan the QR code that directs software on the first mobile device to download data from a website via a cellular network connection. Once received, the first mobile device may utilize a Bluetooth LE transceiver to broadcast the downloaded data. The transmitter device may receive the broadcast signal from the first mobile device and store the included data within a database. The transmitter device may then begin broadcasting signals that include the downloaded data as well as various indicators that describe a relationship to the QR code. When a second user walks up to the movie theater display, the second user's mobile device may receive the signals broadcast from the transmitter device and may thus may access the data associated with the QR code without downloading via the cellular network.

As another illustration, a transmitter device may be positioned within a city's airport terminal. Baggage handlers working in the terminal may use their mobile devices to access a WiFi network and download information describing the best restaurants in the city, such as in response to transmitting query messages via a Google search website. The transmitter device may receive Bluetooth LE broadcasts from the baggage handlers' mobile devices including the information describing the restaurants, and may repeat that information within broadcasts signals from the transmitter device. Subsequently, a mobile device of a traveler may receive the transmitter device's broadcast signals and be presented with the restaurant information immediately upon the traveler deplaning. Further, with similar transmitter devices in airports of other cities, travelers may receive real-time, relevant information about the various cities.

FIG. 11 illustrates primary components of a transmitter device 142 suitable for use in various embodiments. The transmitter device 142 may include a short-range radio 1104 capable of communicating with a short-range wireless radio (e.g., a Bluetooth® radio) and coupled to an antenna 1106. The transmitter device 142 may also include a processor 1102, a memory 1112, and a battery 1110 either as the primary power supply or as a backup power supply in the case of transmitter device 142 coupled to utility power. Although these components are shown linked by a common connection, they may interconnected and configured in various ways. Since these components may be microchips of standard or off-the-shelf configuration, they are represented in FIG. 11 as blocks consistent with the structure of an example embodiment.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory processor-readable storage medium or a non-transitory server-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for a mobile device to share information with proximate devices via short-range wireless signals, comprising:
determining whether the mobile device should obtain data from a primary data source via long-range wireless communications;
obtaining the data in response to determining that the mobile device should obtain the data from the primary data source;
receiving a short-range wireless signal that includes the data in response to determining that the mobile device should not obtain the data; and
determining whether the data is useful in response to receiving the data via the short-range wireless signal.

2. The method of claim 1, wherein the data includes at least one of Global Positioning System (GPS) fix information, music track information, coupons, shopping information, weather reports, local traffic, or any type of sensor reading.

3. The method of claim 1, further comprising:
transmitting a coordination request to a central server;
receiving a coordination request response including a command for the mobile device to perform, and
wherein determining whether the mobile device should obtain data via long-range wireless communications is based on whether the command in the coordination request response indicates the mobile device should obtain the data.

4. The method of claim 1, wherein determining whether the data is useful in response to receiving the data via the short-range wireless signal comprises:
evaluating metadata within the received short-range wireless signal; and
determining whether the data is useful based on the evaluated metadata,
wherein the metadata indicates at least one of whether the data corresponds to an application executed by the mobile device, a margin of error, a signal strength indicator, a timestamp, and a number of previous recipients of the data.

5. The method of claim 4, further comprising:
transmitting a validation message based on the received short-range wireless signal to a central server;
determining that the data is useful when a confirmation message is received from the central server that indicates the received short-range wireless signal was broadcast by a known device; and
determining that the data is useful when the confirmation message is received from the central server that indicates the data within the received short-range wireless signal was valid.

6. The method of claim 4, further comprising:
determining whether the received short-range wireless signal contains identification information corresponding to a known device; and
determining that the data is not useful when the received short-range wireless signal does not contain identification information corresponding to the known device.

7. The method of claim 1, further comprising broadcasting the data via short-range wireless signals based on at least one of whether the mobile device is outside or inside a structure, whether the mobile device is in a desolate area, a current battery capacity of the mobile device, a number of the proximate devices, whether the mobile device is connected to a power source, and error band information corresponding to the data.

8. The method of claim 7, wherein broadcasting the data via short-range wireless signals comprises:
generating metadata based on the data;
generating a message the includes the data and the generated metadata;
activating a short-range wireless transceiver;
broadcasting the generated message via the activated short-range wireless transceiver; and
deactivating the short-range wireless transceiver in response to broadcasting the generated message.

9. The method of claim 1, wherein determining whether the mobile device should obtain data via long-range wireless communications is based on at least one of load-balancing information, user inputs, changes in wireless network access points, sensor information, and an age of information stored within the mobile device.

10. The method of claim 9, wherein load-balancing information includes at least one of a frequency at which the mobile device obtains the data, a time the data was last obtained, previous travel patterns of the mobile device, a number of the proximate devices, available battery power of the proximate devices, whether it is a turn of the mobile device to obtain the data, and a popularity of an area.

11. The method of claim 1, wherein determining whether the mobile device should obtain data from a primary data source via long-range wireless communications comprises:
identifying a first availability of the mobile device to obtain the data based on locally stored data;
broadcasting a message indicating the first availability;
receiving a response message from a proximate device that includes scheduling information, wherein the scheduling information includes at least one of a second availability information of the proximate device, a time claimed by the proximate device, and a confirmation of the first availability;
establishing conditions that define when the mobile device will obtain the data from the primary data source based on the first availability and the scheduling information, wherein the conditions include at least a time of day and a day of a week; and
determining that the mobile device should obtain the data when the established conditions are met.

12. The method of claim 1, further comprising:
storing the data in an operating system table in response to determining that the data is useful or in response to obtaining the data via long-range communications; and
providing the stored data to an application executing on the mobile device.

13. The method of claim 1, wherein the primary data source is at least one of a data server, a website, or a GPS satellite.

14. The method of claim 1, wherein the data is music track information and wherein determining whether the data is useful in response to receiving the data via the short-range wireless signal comprises:
determining that the data is not useful in response to determining that the short-range wireless signal was received after a music track was no longer playing;
recording an audio sample having a short duration with a microphone in response to determining a first number of previous recipients of the data;
recording the audio sample having a long duration with the microphone in response to determining a second number of previous recipients of the data;
transmitting a request message to a music server based on the recorded audio sample and the data received within the received short-range wireless signal; and
determining that the data is useful when a confirmation from the music server is received in response to transmitting the request message.

15. The method of claim 1, wherein determining whether the mobile device should obtain data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

16. The method of claim 15, further comprising transmitting a message indicating whether the mobile device should broadcast the data.

17. A method for a transmitter device positioned within a place to broadcast data relevant to devices within proximity, comprising:
receiving a first short-range wireless signal that includes the data obtained from a primary data source;
determining whether the data within the first signal is useful to the devices within proximity based on whether the data relates to the place;
updating stored data when the data within the first signal is useful to the devices within proximity; and
broadcasting the stored data via a second short-range wireless signal.

18. A mobile device configured to share information with proximate devices via short-range wireless signals, comprising:
means for determining whether the mobile device should obtain data from a primary data source via long-range wireless communications;
means for obtaining the data in response to determining that the mobile device should obtain the data from the primary data source;
means for receiving a short-range wireless signal that includes the data in response to determining that the mobile device should not obtain the data; and
means for determining whether the data is useful in response to receiving the data via the short-range wireless signal.

19. The mobile device of claim 18, wherein the data includes at least one of Global Positioning System (GPS) fix information, music track information, coupons, shopping information, weather reports, local traffic, or any type of sensor reading.

20. The mobile device of claim 18, further comprising:
means for transmitting a coordination request to a central server;
means for receiving a coordination request response including a command for the mobile device to perform, and
wherein means for determining whether the mobile device should obtain data via long-range wireless communications is based on whether the command in the coordination request response indicates the mobile device should obtain the data.

21. The mobile device of claim 18, wherein means for determining whether the data is useful in response to receiving the data via the short-range wireless signal comprises:
means for evaluating metadata within the received short-range wireless signal; and
means for determining whether the data is useful based on the evaluated metadata,
wherein the metadata indicates at least one of whether the data corresponds to an application executed by the mobile device, a margin of error, a signal strength indicator, a timestamp, and a number of previous recipients of the data.

22. The mobile device of claim 21, further comprising:
means for transmitting a validation message based on the received short-range wireless signal to a central server;
means for determining that the data is useful when a confirmation message is received from the central server that indicates the received short-range wireless signal was broadcast by a known device; and
means for determining that the data is useful when the confirmation message is received from the central server that indicates the data within the received short-range wireless signal was valid.

23. The mobile device of claim 21, further comprising:
means for determining whether the received short-range wireless signal contains identification information corresponding to a known device; and
means for determining that the data is not useful when the received short-range wireless signal does not contain identification information corresponding to the known device.

24. The mobile device of claim 18, further comprising means for broadcasting the data via short-range wireless signals based on at least one of whether the mobile device is outside or inside a structure, whether the mobile device is in a desolate area, a current battery capacity of the mobile device, a number of the proximate devices, whether the mobile device is connected to a power source, and error band information corresponding to the data.

25. The mobile device of claim 24, further comprising a short-range wireless transceiver, wherein means for broadcasting the data via short-range wireless signals comprises:
means for generating metadata based on the data;
means for generating a message the includes the data and the generated metadata;
means for activating the short-range wireless transceiver;
means for broadcasting the generated message via the activated short-range wireless transceiver; and
means for deactivating the short-range wireless transceiver in response to broadcasting the generated message.

26. The mobile device of claim 18, wherein means for determining whether the mobile device should obtain data via long-range wireless communications comprises means for determining whether the mobile device should obtain data via long-range wireless communications based on at least one of load-balancing information, user inputs, changes in wireless network access points, sensor information, and an age of information stored within the mobile device.

27. The mobile device of claim 26, wherein load-balancing information includes at least one of a frequency at which the mobile device obtains the data, a time the data was last obtained, previous travel patterns of the mobile device, a number of the proximate devices, available battery power of the proximate devices, whether it is a turn of the mobile device to obtain the data, and a popularity of an area.

28. The mobile device of claim 18, wherein means for determining whether the mobile device should obtain data from a primary data source via long-range wireless communications comprises:
means for identifying a first availability of the mobile device to obtain the data based on locally stored data;
means for broadcasting a message indicating the first availability;
means for receiving a response message from a proximate device that includes scheduling information, wherein the scheduling information includes at least one of a second availability information of the proximate device, a time claimed by the proximate device, and a confirmation of the first availability;
means for establishing conditions that define when the mobile device will obtain the data from the primary data source based on the first availability and the scheduling information, wherein the conditions include at least a time of day and a day of a week; and
means for determining that the mobile device should obtain the data when the established conditions are met.

29. The mobile device of claim 18, further comprising:
means for storing the data in an operating system table in response to determining that the data is useful or in response to obtaining the data via long-range communications; and
means for providing the stored data to an application executing on the mobile device.

30. The mobile device of claim 18, wherein the primary data source is at least one of a data server, a website, or a Global Positioning System (GPS) satellite.

31. The mobile device of claim 18, wherein the data is music track information and wherein means for determining whether the data is useful in response to receiving the data via the short-range wireless signal comprises:
means for determining that the data is not useful in response to determining that the short-range wireless signal was received after a music track was no longer playing;
means for recording an audio sample having a short duration with a microphone in response to determining a first number of previous recipients of the data;
means for recording the audio sample having a long duration with the microphone in response to determining a second number of previous recipients of the data;
means for transmitting a request message to a music server based on the recorded audio sample and the data received within the received short-range wireless signal; and
means for determining that the data is useful when a confirmation from the music server is received in response to transmitting the request message.

32. The mobile device of claim 18, wherein means for determining whether the mobile device should obtain data from a primary data source via long-range wireless communications comprises:
means for identifying a current area corresponding to the mobile device;
means for identifying when the mobile device last obtained the data;
means for identifying a frequency at which the mobile device obtains the data via long-range communications;
means for identifying proximate devices within the identified current area;
means for identifying when the identified proximate devices last obtained the data;
means for identifying an availability of the identified proximate devices to obtain and broadcast the data; and
means for identifying available power of the mobile device and the identified proximate devices.

33. A server, comprising:
means for receiving a coordination request message corresponding to data;
means for determining whether a mobile device should obtain the data from a primary data source via long-range wireless communications; and
means for transmitting a first message that includes a command for the mobile device to obtain the data from the primary data source.

34. The server of claim 33, wherein means for determining whether a mobile device should obtain the data from a primary data source via long-range wireless communications comprises:
means for identifying a current area corresponding to the mobile device;
means for identifying when the mobile device last obtained the data;
means for identifying a frequency at which the mobile device obtains the data via long-range communications;
means for identifying proximate devices within the identified current area;
means for identifying when the identified proximate devices last obtained the data;
means for identifying an availability of the identified proximate devices to obtain and broadcast the data; and
means for identifying available power of the mobile device and the identified proximate devices.

35. The server of claim 33, further comprising means for transmitting a second message indicating whether the mobile device should broadcast the data.

36. The server of claim 33, further comprising:
means for receiving a validation message from the mobile device based on a received short-range wireless signal;
means for determining whether the validation message corresponds to a known device;
means for determining whether the data indicated in the validation message is valid; and
means for transmitting a confirmation message to the mobile device when the validation message corresponds to the known device or the data is valid.

37. A transmitter device positioned within a place and configured to broadcast data relevant to devices within proximity, comprising:
means for receiving a first short-range wireless signal that includes the data obtained from a primary data source;
means for determining whether the data within the first signal is useful to the devices within proximity based on whether the data relates to the place;
means for updating stored data when the data within the first signal is useful to the devices within proximity; and
means for broadcasting the stored data via a second short-range wireless signal.

38. A mobile device configured to share information with proximate devices via short-range wireless signals, comprising:
a memory; and
a processor coupled to the memory, wherein the processor is configured with processor-executable instructions to perform operations comprising:
determining whether the mobile device should obtain data from a primary data source via long-range wireless communications;
obtaining the data in response to determining that the mobile device should obtain the data from the primary data source;
receiving a short-range wireless signal that includes the data in response to determining that the mobile device should not obtain the data; and
determining whether the data is useful in response to receiving the data via the short-range wireless signal.

39. The mobile device of claim 38, wherein the data includes at least one of Global Positioning System (GPS) fix information, music track information, coupons, shopping information, weather reports, local traffic, or any type of sensor reading.

40. The mobile device of claim 38, wherein the processor is configured with processor-executable instructions to perform operations further comprising:
transmitting a coordination request to a central server;
receiving a coordination request response including a command for the mobile device to perform, and
wherein the processor is configured with processor-executable instructions to perform operations such that determining whether the mobile device should obtain data via long-range wireless communications is based on whether the command in the coordination request response indicates the mobile device should obtain the data.

41. The mobile device of claim 38, wherein the processor is configured with processor-executable instructions to perform operations such that determining whether the data is useful in response to receiving the data via the short-range wireless signal comprises:
evaluating metadata within the received short-range wireless signal; and
determining whether the data is useful based on the evaluated metadata,
wherein the metadata indicates at least one of whether the data corresponds to an application executed by the mobile device, a margin of error, a signal strength indicator, a timestamp, and a number of previous recipients of the data.

42. The mobile device of claim 41, wherein the processor is configured with processor-executable instructions to perform operations further comprising:
transmitting a validation message based on the received short-range wireless signal to a central server;
determining that the data is useful when a confirmation message is received from the central server that indicates the received short-range wireless signal was broadcast by a known device; and
determining that the data is useful when the confirmation message is received from the central server that indicates the data within the received short-range wireless signal was valid.

43. The mobile device of claim 41, wherein the processor is configured with processor-executable instructions to perform operations further comprising:
determining whether the received short-range wireless signal contains identification information corresponding to a known device; and
determining that the data is not useful when the received short-range wireless signal does not contain identification information corresponding to the known device.

44. The mobile device of claim 38, wherein the processor is configured with processor-executable instructions to perform operations further comprising broadcasting the data via short-range wireless signals based on at least one of whether the mobile device is outside or inside a structure whether the mobile device is in a desolate area, a current battery capacity of the mobile device, a number of the proximate devices, whether the mobile device is connected to a power source, and error band information corresponding to the data.

45. The mobile device of claim 44, wherein the processor is configured with processor-executable instructions to perform operations such that broadcasting the data via short-range wireless signals comprises:
generating metadata based on the data;
generating a message the includes the data and the generated metadata;
activating a short-range wireless transceiver;
broadcasting the generated message via the activated short-range wireless transceiver; and
deactivating the short-range wireless transceiver in response to broadcasting the generated message.

46. The mobile device of claim 38, wherein the processor is configured with processor-executable instructions to perform operations such that determining whether the mobile device should obtain data via long-range wireless communications is based on at least one of load-balancing information, user inputs, changes in wireless network access points, sensor information, and an age of information stored within the mobile device.

47. The mobile device of claim 46, wherein load-balancing information includes at least one of a frequency at which the mobile device obtains the data, a time the data was last obtained, previous travel patterns of the mobile device, a number of the proximate devices, available battery power of the proximate devices, whether it is a turn of the mobile device to obtain the data, and a popularity of an area.

48. The mobile device of claim 38, wherein the processor is configured with processor-executable instructions to perform operations such that determining whether the mobile device should obtain data from a primary data source via long-range wireless communications comprises:
identifying a first availability of the mobile device to obtain the data based on locally stored data;
broadcasting a message indicating the first availability;
receiving a response message from a proximate device that includes scheduling information, wherein the scheduling information includes at least one of a second availability information of the proximate device, a time claimed by the proximate device, and a confirmation of the first availability;
establishing conditions that define when the mobile device will obtain the data from the primary data source based on the first availability and the scheduling information, wherein the conditions include at least a time of day and a day of a week; and
determining that the mobile device should obtain the data when the established conditions are met.

49. The mobile device of claim 38, wherein the processor is configured with processor-executable instructions to perform operations further comprising:
storing the data in an operating system table in response to determining that the data is useful or in response to obtaining the data via long-range communications; and
providing the stored data to an application executing on the mobile device.

50. The mobile device of claim 38, wherein the primary data source is at least one of a data server, a website, or a Global Positioning System (GPS) satellite.

51. The mobile device of claim 38, wherein the data is music track information and wherein the processor is configured with processor-executable instructions to perform operations such that determining whether the data is useful in response to receiving the data via the short-range wireless signal comprises:
determining that the data is not useful in response to determining that the short-range wireless signal was received after a music track was no longer playing;
recording an audio sample having a short duration with a microphone in response to determining a first number of previous recipients of the data;
recording the audio sample having a long duration with the microphone in response to determining a second number of previous recipients of the data;
transmitting a request message to a music server based on the recorded audio sample and the data received within the received short-range wireless signal; and
determining that the data is useful when a confirmation from the music server is received in response to transmitting the request message.

52. The mobile device of claim 38, wherein the processor is configured with processor-executable instructions to perform operations such that determining whether the mobile device should obtain data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

53. A server, comprising:
a memory; and
a server processor coupled to the memory, wherein the server processor is configured with server processor-executable instructions to perform operations comprising:
receiving a coordination request message corresponding to data;
determining whether a mobile device should obtain the data from a primary data source via long-range wireless communications; and
transmitting a first message that includes a command for the mobile device to obtain the data from the primary data source.

54. The server of claim 53, wherein the server processor is configured with server processor-executable instructions to perform operations such that determining whether a mobile device should obtain the data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

55. The server of claim 53, wherein the server processor is configured with server processor-executable instructions to perform operations further comprising transmitting a second message indicating whether the mobile device should broadcast the data.

56. The server of claim 53, wherein the server processor is configured with server processor-executable instructions to perform operations further comprising:
receiving a validation message from the mobile device based on a received short-range wireless signal;
determining whether the validation message corresponds to a known device;
determining whether the data indicated in the validation message is valid; and
transmitting a confirmation message to the mobile device when the validation message corresponds to the known device or the data is valid.

57. A transmitter device positioned within a place and configured to broadcast data relevant to devices within proximity, comprising:
a memory; and
a processor coupled to the memory, wherein the processor is configured with processor-executable instructions to perform operations comprising:
receiving a first short-range wireless signal that includes the data obtained from a primary data source;
determining whether the data within the first signal is useful to the devices within proximity based on whether the data relates to the place;
updating stored data when the data within the first signal is useful to the devices within proximity; and
broadcasting the stored data via a second short-range wireless signal.

58. A non-transitory processor-readable storage medium having stored thereon processor-executable software instructions configured to cause a processor to perform operations for a mobile device to share information with proximate devices via short-range wireless signals, the operations comprising:
determining whether the mobile device should obtain data from a primary data source via long-range wireless communications;
obtaining the data in response to determining that the mobile device should obtain the data from the primary data source;
receiving a short-range wireless signal that includes the data in response to determining that the mobile device should not obtain the data; and
determining whether the data is useful in response to receiving the data via the short-range wireless signal.

59. The non-transitory processor-readable storage medium of claim 58, wherein the data includes at least one of Global Positioning System (GPS) fix information, music track information, coupons, shopping information, weather reports, local traffic, or any type of sensor reading.

60. The non-transitory processor-readable storage medium of claim 58, wherein the stored processor-executable software instructions are configured to cause the processor to perform operations further comprising:
transmitting a coordination request to a central server; and
receiving a coordination request response including a command for the mobile device to perform, and
wherein the stored processor-executable software instructions are configured to cause the processor to perform operations such that determining whether the mobile device should obtain data via long-range wireless communications is based on whether the command in the coordination request response indicates the mobile device should obtain the data.

61. The non-transitory processor-readable storage medium of claim 58, wherein the stored processor-executable software instructions are configured to cause the processor to perform operations such that determining whether the data is useful in response to receiving the data via the short-range wireless signal comprises:
evaluating metadata within the received short-range wireless signal; and
determining whether the data is useful based on the evaluated metadata,
wherein the metadata indicates at least one of whether the data corresponds to an application executed by the mobile device, a margin of error, a signal strength indicator, a timestamp, and a number of previous recipients of the data.

62. The non-transitory processor-readable storage medium of claim 61, wherein the stored processor-executable software instructions are configured to cause the processor to perform operations further comprising:
transmitting a validation message based on the received short-range wireless signal to a central server;
determining that the data is useful when a confirmation message is received from the central server that indicates the received short-range wireless signal was broadcast by a known device; and
determining that the data is useful when the confirmation message is received from the central server that indicates the data within the received short-range wireless signal was valid.

63. The non-transitory processor-readable storage medium of claim 61, wherein the stored processor-executable software instructions are configured to cause the processor to perform operations further comprising:
determining whether the received short-range wireless signal contains identification information corresponding to a known device; and
determining that the data is not useful when the received short-range wireless signal does not contain identification information corresponding to the known device.

64. The non-transitory processor-readable storage medium of claim 58, wherein the stored processor-executable software instructions are configured to cause the processor to perform operations further comprising broadcasting the data via short-range wireless signals based on at least one of whether the mobile device is outside or inside a structure whether the mobile device is in a desolate area, a current battery capacity of the mobile device, a number of the proximate devices, whether the mobile device is connected to a power source, and error band information corresponding to the data.

65. The non-transitory processor-readable storage medium of claim 64, wherein the stored processor-executable software instructions are configured to cause the processor to perform operations such that broadcasting the data via short-range wireless signals comprises:
generating metadata based on the data;
generating a message the includes the data and the generated metadata;
activating a short-range wireless transceiver;
broadcasting the generated message via the activated short-range wireless transceiver; and
deactivating the short-range wireless transceiver in response to broadcasting the generated message.

66. The non-transitory processor-readable storage medium of claim 58, wherein the stored processor-executable software instructions are configured to cause the processor to perform operations such that determining whether the mobile device should obtain data via long-range wireless communications is based on at least one of load-balancing information, user inputs, changes in wireless network access points, sensor information, and an age of information stored within the mobile device.

67. The non-transitory processor-readable storage medium of claim 66, wherein load-balancing information includes at least one of a frequency at which the mobile device obtains the data, a time the data was last obtained, previous travel patterns of the mobile device, a number of the proximate devices, available battery power of the proximate devices, whether it is a turn of the mobile device to obtain the data, and a popularity of an area.

68. The non-transitory processor-readable storage medium of claim 58, wherein the stored processor-executable software instructions are configured to cause the processor to perform operations such that determining whether the mobile device should obtain data from a primary data source via long-range wireless communications comprises:
identifying a first availability of the mobile device to obtain the data based on locally stored data;
broadcasting a message indicating the first availability;
receiving a response message from a proximate device that includes scheduling information, wherein the scheduling information includes at least one of a second availability information of the proximate device, a time claimed by the proximate device, and a confirmation of the first availability;
establishing conditions that define when the mobile device will obtain the data from the primary data source based on the first availability and the scheduling information, wherein the conditions include at least a time of day and a day of a week; and
determining that the mobile device should obtain the data when the established conditions are met.

69. The non-transitory processor-readable storage medium of claim 58, wherein the stored processor-executable software instructions are configured to cause the processor to perform operations further comprising:
storing the data in an operating system table in response to determining that the data is useful or in response to obtaining the data via long-range communications; and
providing the stored data to an application executing on the mobile device.

70. The non-transitory processor-readable storage medium of claim 58, wherein the primary data source is at least one of a data server, a website, or a Global Positioning System (GPS) satellite.

71. The non-transitory processor-readable storage medium of claim 58, wherein the data is music track information and wherein the stored processor-executable software instructions are configured to cause the processor to perform operations such that determining whether the data is useful in response to receiving the data via the short-range wireless signal comprises:
determining that the data is not useful in response to determining that the short-range wireless signal was received after a music track was no longer playing;
recording an audio sample having a short duration with a microphone in response to determining a first number of previous recipients of the data;
recording the audio sample having a long duration with the microphone in response to determining a second number of previous recipients of the data;
transmitting a request message to a music server based on the recorded audio sample and the data received within the received short-range wireless signal; and
determining that the data is useful when a confirmation from the music server is received in response to transmitting the request message.

72. The non-transitory processor-readable storage medium of claim 58, wherein the stored processor-executable software instructions are configured to cause the processor to perform operations such that determining whether the mobile device should obtain data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

73. A non-transitory server processor-readable storage medium having stored thereon server processor-executable software instructions configured to cause a server processor to perform operations comprising:
receiving a coordination request message corresponding to data;
determining whether a mobile device should obtain the data from a primary data source via long-range wireless communications; and
transmitting a first message that includes a command for the mobile device to obtain the data from the primary data source.

74. The non-transitory server processor-readable storage medium of claim 73, wherein the stored server processor-executable software instructions are configured to cause the server processor to perform operations such that determining whether a mobile device should obtain the data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

75. The non-transitory server processor-readable storage medium of claim 73, wherein the stored server processor-executable software instructions are configured to cause the server processor to perform operations further comprising transmitting a second message indicating whether the mobile device should broadcast the data.

76. The non-transitory server processor-readable storage medium of claim 73, wherein the stored server processor-executable software instructions are configured to cause the server processor to perform operations further comprising:
receiving a validation message from the mobile device based on a received short-range wireless signal;
determining whether the validation message corresponds to a known device;
determining whether the data indicated in the validation message is valid; and
transmitting a confirmation message to the mobile device when the validation message corresponds to the known device or the data is valid.

77. A non-transitory processor-readable storage medium having stored thereon processor-executable software instructions configured to cause a processor to perform operations for a transmitter device positioned within a place to broadcast data relevant to devices within proximity, comprising:
receiving a first short-range wireless signal that includes the data obtained from a primary data source;
determining whether the data within the first signal is useful to the devices within proximity based on whether the data relates to the place;
updating stored data when the data within the first signal is useful to the devices within proximity; and
broadcasting the stored data via a second short-range wireless signal.

78. A system, comprising:
a server; and
a mobile device,
wherein the server is configured with server-executable instructions to perform operations comprising:
receiving a coordination request message corresponding to data;
determining whether the mobile device should obtain the data from a primary data source via long-range wireless communications; and
transmitting a first message that includes a command for the mobile device to obtain the data from the primary data source, and
wherein the mobile device comprises:
a memory;
a first transceiver configured to communicate with a network coupled to the server;
a second transceiver configured to broadcast short-range wireless signals; and
a processor coupled to the memory, the first transceiver, and the second transceiver, and configured with processor-executable instructions to perform operations comprising:
transmitting to the server via the first transceiver the coordination request message corresponding to the data;
receiving the first message from the server via the first transceiver;
obtaining the data when the first message includes the command to obtain the data from the primary data source; and
broadcasting the data via the second transceiver.

79. The system of claim 78, wherein the processor is configured with processor-executable instructions to perform operations such that broadcasting the data comprises broadcasting the data via the second transceiver based on at least one of whether the mobile device is outside or inside a structure whether the mobile device is in a desolate area, a current battery capacity of the mobile device, a number of the proximate devices, whether the mobile device is connected to a power source, and error band information corresponding to the data.

80. The system of claim 78, wherein the server is configured with server-executable instructions to perform operations such that determining whether the mobile device should obtain the data from a primary data source via long-range wireless communications comprises:
identifying a current area corresponding to the mobile device;
identifying when the mobile device last obtained the data;
identifying a frequency at which the mobile device obtains the data via long-range communications;
identifying proximate devices within the identified current area;
identifying when the identified proximate devices last obtained the data;
identifying an availability of the identified proximate devices to obtain and broadcast the data; and
identifying available power of the mobile device and the identified proximate devices.

81. The system of claim 78, wherein the server is configured with server-executable instructions to perform operations further comprising transmitting a second message indicating whether the mobile device should broadcast the data, and
wherein the processor is configured with processor-executable instructions to perform operations such that broadcasting the data comprises broadcasting the data via the second transceiver in response to receiving the second message.

82. The system of claim 78, wherein the server is configured with server-executable instructions to perform operations further comprising:
receiving a validation message from the mobile device based on a received short-range wireless signal;
determining whether the validation message corresponds to a known device;
determining whether the data indicated in the validation message is valid; and
transmitting a confirmation message to the mobile device when the validation message corresponds to the known device or the data is valid, and
wherein the processor is configured with processor-executable instructions to perform operations further comprising:
receiving the short-range wireless signal via the second transceiver; and
transmitting via the first transceiver the validation message in response to receiving the short-range wireless signal.

83. The system of claim 78, further comprising:
a transmitter device positioned within a place, comprising:
a device memory;
a device transceiver configured to broadcast short-range wireless signals; and
a device processor coupled to the memory and the transceiver of the transmitter device, and configured with processor-executable instructions to perform operations comprising:
receiving via the transceiver of the transmitter device the data broadcast by the mobile device;
determining whether the received data is useful to devices within proximity based on whether the data relates to the place;
updating stored data when the received data is useful to the devices within proximity; and
broadcasting via the transceiver of the transmitter device the stored data.
